(19) United States
(12) Patent Application Publication
(10) Pub. No.: US 2009/0231308 A1
(43) Pub. Date: Sep. 17, 2009

(54) Display Device and Driving Method Thereof

(76) Inventor: Takaji Numao, Nara (JP)

Correspondence Address: HARNESS, DICKEY & PIERCE, P.L.C., P.O. BOX 8910, RESTON, VA, 20195, US

(21) Appl. No.: 11/887,252

(22) PCT Filed: Oct. 25, 2005
(86) PCT No.: PCT/JP2005/019569

§ 371 Date: Sep. 27, 2007

(30) Foreign Application Priority Data
Mar. 29, 2005 (JP) 2005-096368

(51) Int. Cl. G06F 3/038

(52) U.S. Cl. 345/204; 345/76

(57) ABSTRACT

In one embodiment of the present invention, capacitors are provided in series between the source and gate of a transistor which is a driver TFT. A predetermined voltage is applied to contact of the capacitors in a first period so as to apply a data voltage to the gate of the transistor from a source line. In a second period, the transistor is threshold compensated. The contact of the capacitors is opened in the third period, thereby short-circuiting the capacitor to apply a voltage having been subjected to threshold compensation to a point between the gate and source of the transistor. This pixel circuit structure, in which the driver TFT driving an OLED or another current-driven-type display element is threshold compensated, contains a reduced number of elements per pixel to increases the number of display pixels.

### TECHNICAL FIELD

The present invention relates to OLED (organic light emitting diode) displays, FEDs (field emission displays), and other display devices which utilize current-driven elements and to their driving methods.

### BACKGROUND ART

We have seen in recent years a lot of research and development activities for current-driven light emitting elements used in OLEDs and FEDs. Among them, the OLED display is attracting especially much attention for its light emitting capability on low voltage and low power consumption with prospective applications in mobile devices such as mobile phones and PDAs (personal digital assistants).

A pixel circuit structure for the OLED display, as discussed in document 1 (Japanese Unexamined Patent Publication (Tokukai) 2003-173165), is shown in FIG. 21.

A pixel circuit shown in FIG. 21 contains a p-type TFT (thin film transistor) 17, three switches SW1 to SW3, a pixel switch 13, two capacitors 18, 20, and an OLED 16. Between a power supply line VEL and a common cathode (GND) are there provided a TFT 17, a switch SW1, and an OLED 16 connected in series. The capacitor 18 is connected between the gate of the TFT 17 and the power supply line (potential VEL). The capacitor 20 and the pixel switch 13 connected in series between the gate of the TFT 17 and a signal line 12. The switch SW3 is provided between node A where the capacitor 20 is connected to the pixel switch 13 and a reset signal line RESET. The switch SW2 is provided between the gate and drain of the TFT 17.

Nodes B and C denote the gate and drain, respectively, of the TFT 17.

FIG. 22 illustrates the operation of the pixel circuit in relation with potential changes at nodes A to C and the open/closed states of the switches SW1 to SW3 and the pixel switch 13.

The pixel circuit first enters a reset period when the pixel switch 13 is open and SW1 to SW3 are closed. Consequently, the potential at node A rises to Vrst (the potential on the reset line RESET), lowering the potentials at nodes B, C to approach the potential VSS on the common cathode.

Next, the pixel circuit moves into a threshold Vth variation cancelling period when the SW1 is opened, setting node B to VEL−|Vth|. Since the TFT 17 is a p-type TFT and its threshold Vth is generally indicated in negative value, its absolute value is taken.

Then, the pixel circuit enters a video signal write period when the switches SW2, W3 are opened, thereby closing the pixel switch 13. This changes the potential at node A from Vrst to Vsig (video signal potential), which in turn changes the potential at node B. The potential at node B is maintained by opening the pixel switch 13. Closing the switch SW1 starts a video signal display period corresponding to the potential at node B.

The use of the pixel circuit in FIG. 21 as above compensates the gate potential of the TFT 17 for the effect of the threshold Vth for the TFT 17.

Another pixel circuit structure for the OLED display is disclosed in document 2 (Japanese Unexamined Patent Publication (Tokukai) 2004-246204). The circuit structure is shown in FIG. 23.

A pixel circuit 30 in FIG. 23 includes five p-type TFTs 31 to 35, two capacitors C31, C32, and an OLED 36. The TFTs 32, 31 and OLED 36 are connected in series between a power supply line VDD and a common cathode (GND). The TFT 35 is provided between the gate of the TFT 31 and a power supply line (predetermined potential Vpc). The capacitor C31 and TFT 34 are provided in series between the gate of the TFT 31 and a data line DTL31. The TFT 33 is provided between a node ND31 and the source of the TFT 31. The node ND31 provides a contact of the capacitor C31 and the TFT 34. The capacitor C32 is provided between the node ND31 and a power supply line (power supply potential VDD).

The gate of the TFT 32 is connected to a drive line DRVL31, the gates of the TFTs 33, 35 to an auto zero line AZL31, and the gate of the TFT 34 to a scan line SCNL31.

FIG. 24 illustrates the potentials of various lines and the changes of the potentials Vc31, Vg31. Vc31 is the potential at node ND31. Vg31 is the gate potential of the TFT 31.

In this pixel circuit 30, first, the drive line DRVL31 and the auto zero line AZL31 are LOW, turning on the TFTs 32, 33, 35.

As a result, the gate potential Vg31 of the TFT 31 changes to the precharge potential Vpc because the TFT 35 is ON. The potential Vc31 at node ND31 rises to or approaches the power supply potential VDD because the TFTs 32, 33 are ON.

Next, the drive line DRVL31 goes HIGH. That turns off the TFT 32 and cuts off the current flow to the TFT 31, lowering the source potential of the TFT 31. The source potential becomes stable when it falls to Vpc+|Vth| since the TFT 31 is turned off. The potential Vc31 at node ND31 is also Vpc+|Vth| because the TFT 33 is ON. |Vth| is the absolute value of the threshold for the TFT 31.

Next, the auto zero line AZL31 goes HIGH, turning off the TFTs 33, 35. Now, the potential Vc31 at node ND31 is Vpc+|Vth|, and the gate potential Vg31 of the TFT 31 is Vpc, which means that the potential difference across the capacitor C31 is |Vth|.

Furthermore, in a one horizontal select period, the scan line SCNL31 goes LOW, turning on the TFT 34. A potential Vdata in accordance with luminance data is applied from the data line DTL31 to node ND31. Under these conditions, the potential difference across the capacitor C31 is maintained at |Vth|. The gate potential Vg31 of the TFT 31 therefore equals Vdata−|Vth|.

Finally, the scan line SCNL31 goes HIGH, turning off the TFT 34, and the drive line DRVL31 goes LOW, turning on the TFT 32. That creates a current flow through the TFT 31 and the OLED 36, illuminating the OLED.

The use of the pixel circuit in FIG. 23 as above produces a display with the effect of the threshold Vth for the TFT 17 being removed.

The use of the pixel circuit in FIG. 21 or FIG. 23 as above allows a desired current to be fed to the OLED independently of the threshold voltage of the driver TFT.

However, the pixel circuits in FIG. 21 and FIG. 23 require three switching TFTs to charge/discharge the capacitors. In the FIG. 21 pixel circuit, the switch SW3 and the pixel switch 13 are connected to node A of the capacitor 20. The switch SW2 is connected to the gate of the TFT 17. These switches are all TFTs. If their off leak currents are large, the capacitors 20 and 18 cannot maintain their electric charge, altering the gate potential of the TFT 17.

For these reasons, the switches SW2, SW3 and the pixel switch 13 each need to be constructed of two LDD (lightly doped drain) TFTs connected in series to reduce the off leak current.

An LDD TFT needs a lightly doped area on both sides of its gate electrode, which adds an extra length compared to an ordinary TFT. On top of that, each of the switches SW2, SW3, and 13 contains two of them connected in series and therefore requires greater area than an ordinary TFT to be accommodated.

The same issues exist in the pixel circuit in FIG. 23. Referring to the pixel circuit in FIG. 23, unless the capacitors C31 and C32 are capable of maintaining their electric charge, the gate potential of the TFT 31 alters.

To overcome this problem, the TFTs 33 to 35 each need to be constructed of two LDD TFTs connected in series. Greater area is needed to accommodate the TFTs 33 to 35 than three ordinary TFTs.

The additional footprint requirement for the accommodation of a necessary number of TFTs presents an obstacle in reducing pixel size even if a top emission structure is employed. A problem may follow where a suitable number of pixels to achieve a desired resolution cannot be packed in a predetermined screen size.

### DISCLOSURE OF INVENTION

The present invention, aimed at addressing the problems, has a major objective (first objective) of reducing the number of elements and wires making up a screen. That allows for pixel size reduction (albeit small) and more pixel accommodation in a predetermined screen size, which will lead to image quality improvement.

Even if the number of elements making up a screen is reduced, and more pixels are accommodated in a predetermined screen size, image quality can deteriorate if luminance varies greatly from one pixel to the other. The present invention has another objective (second objective) of accommodating more pixels in a predetermined screen size without causing such image quality deterioration, which will lead to successful image quality improvement.

The display device in accordance with the present invention includes a matrix of electro-optical elements and driver transistors driving the electro-optical elements, and to achieve the objectives, is characterized in that it includes at each matrix point: a first capacitor and a second capacitor provided in series between a current control terminal and first current input/output terminal of an associated one of the driver transistors; a first switching transistor having a first current input/output terminal connected to the current control terminal of that driver transistor; a second switching transistor having a first current input/output terminal connected a contact of the first and second capacitors; current input/output control means for controlling a current input or output of the driver transistor so as to produce a potential difference equal to a threshold voltage of the driver transistor between the current control terminal and first current input/output terminal of the driver transistor; and potential control means for changing a potential of the current control terminal of the driver transistor while there exists a potential difference equal to the threshold voltage between the current control terminal and first current input/output terminal of the driver transistor.

In this configuration, the current input/output control means turns on the driver transistor before current input or output of the driver transistor is suspended. That sets the potential difference between the current control terminal and first current input/output terminal of the driver transistor equal to the threshold voltage. Thereafter, the potential control means changes the potential of the current control terminal of the driver transistor. That applies a threshold-voltage compensated voltage to the gate of the driver transistor.

Accordingly, the device is capable of threshold-voltage compensation for the driver transistor with only two switching transistors that charge/discharge the first and second capacitors. Therefore, the device contains a reduced number of transistors (LDD TFTs).

The current input/output control means may be configured in one of the two ways below.

A first current input/output control means includes a third switching transistor having a first current input/output terminal connected to the first current input/output terminal of the driver transistor.

In this configuration, the third switching transistor is turned off, allowing the potential of the first current input/output terminal of the driver transistor to change. If the driver transistor is on, the potential of the first current input/output terminal of the driver transistor starts to change.

When the current control terminal and first current input/output terminal of the driver transistor come to have a potential difference equal to the threshold voltage of the driver transistor, the driver transistor is turned off. That inhibits the voltage of the first current input/output terminal of the driver transistor from changing. As a result, the current control terminal and first current input/output terminal of the driver transistor have a stable potential difference which is equal to the threshold voltage.

Depending on to what the second current input/output terminal of the first switching transistor is connected, three different cases may develop with the first current input/output control means as follows:
The terminal is connected to the signal line to which a display data signal potential is being applied;
The terminal is connected to the potential line to which a predetermined potential is being applied; and
The terminal is connected to the second current input/output terminal of the driver transistor.

In the first case, the second current input/output terminal of the second switching transistor is connected to the potential line. The current control terminal of the driver transistor voltage is held at the same potential as that of the signal line using the first capacitor. The potential difference between the current control terminal and first current input/output terminal of the driver transistor is held until it becomes equal to the threshold voltage.

In the second case, the current control terminal of the driver transistor voltage is held at the same potential as the potential line. The potential difference between the current control terminal and first current input/output terminal of the driver transistor is held until it becomes equal to the threshold voltage.

In the third case, the current control terminal of the driver transistor voltage is connected to the second current input/output terminal of the driver transistor. The potential difference between the current control terminal and first current input/output terminal of the driver transistor is held until it becomes equal to the threshold voltage.

In the third case, there is no need for a potential line. The pixel size can be reduced by that much.

Therefore, the first current input/output control means is preferably characterized in that the second current input/output terminal of the first switching transistor is connected to the second current input/output terminal of the driver transistor.

A second current input/output control means includes a third switching transistor having a first current input/output terminal connected to a second current input/output terminal of the driver transistor, and the first switching transistor has a second current input/output terminal connected to the second current input/output terminal of the driver transistor.

In this configuration, the potential of the second current input/output terminal of the driver transistor can be changed, with the current control terminal and second current input/output terminal of the driver transistor and being connected via the first switching transistor. If the driver transistor is on, electric charge starts to move from the second current input terminal of the driver transistor. Under these conditions, the current control terminal of the driver transistor is connected the second current input/output terminal as above. That also changes the potential of the current control terminal of the driver transistor.

When the current control terminal and first current input/output terminal of the driver transistor come to have a potential difference equal to the threshold voltage Vth of the driver transistor, the driver transistor is turned off. That inhibits the voltage of the current control terminal of the driver transistor from changing. As a result, the current control terminal and first current input/output terminal of the driver transistor have a stable potential difference which is equal to the threshold voltage.

The potential control means which, as described above, sets the potential difference between the current control terminal and first current input/output terminal of the driver transistor to the threshold voltage and thereafter changes the potential of the current control terminal of the driver transistor may be configured in one of the two ways below.

The first potential control means includes a fourth switching transistor provided in parallel with the first capacitor.

In this configuration, both the terminals of the first capacitor can be short-circuit using the fourth switching transistor. As a result, the first capacitor discharges; accordingly the voltage of the current control terminal of the driver transistor changes.

The voltage change starts from the threshold voltage and equals the voltage held by the first capacitor. Therefore, by setting the voltage across the first capacitor to a desired voltage in advance, the threshold-voltage compensated voltage can be applied to the current control terminal of the driver transistor.

The second potential control means is such that the second switching transistor has a second current input/output terminal connected to a signal-feeding signal line.

In this configuration, the voltage of the contact of the first and second capacitors can be changed by feeding a signal from the signal line. By changing the voltage of the contact, the threshold-voltage compensated voltage can be applied to the current control terminal of the driver transistor.

The driving method of the present invention, to achieve the objectives, involves a display device including a matrix of electro-optical elements and driver transistors driving the electro-optical elements, the device including at each matrix point a first capacitor and a second capacitor provided in series between a current control terminal and first current input/output terminal of an associated one of the driver transistors, and is characterized in that the method involves the steps of: applying a first potential to the current control terminal of that driver transistor in a first period and applying a second potential to a contact of the first and second capacitors; controlling a current input to the driver transistor or a current output from the driver transistor in a second period, so as to produce a potential difference equal to a threshold voltage of the driver transistor between the current control terminal and first current input/output terminal of the driver transistor; and changing a potential of the current control terminal in a third period.

According to the driving method, the potential difference across the first capacitor is set in the first period. Next, in the second period, the potential different between the current control terminal and first current input/output terminal of the driver transistor is set equal to the threshold voltage. The potential of the current control terminal of the driver transistor is changed in the third period by either removing potential difference from across the first capacitor or changing the potential of the contact of the first and second capacitors, so as to set to the threshold-voltage compensated voltage.

As described in the foregoing, the display device of the present invention includes a first capacitor and a second capacitor provided in series between a current control terminal and first current input/output terminal of a driver transistors. To charge/discharge the first and second capacitors, a first switching transistor is connected to the current control terminal of the driver transistor, a second switching transistor is connected to a contact of the first and second capacitors. The driver transistor is turned on before current input or output of the driver transistor is suspended. That sets the voltage between the current control terminal and first current input/output terminal of the driver transistor equal to the threshold voltage. Thereafter, the potential of the current control terminal of the driver transistor is changed. That applies a threshold-voltage compensated voltage to the gate of the driver transistor.

The elements required in the above operation are two capacitors and four to five transistors. Of the four to five transistors, no more than two switching transistors (elements which maintain the electric charge of the first capacitor and the second capacitor) are needed. Therefore, the display device of the present invention requires a smaller element footprint per pixel when compared to the conventional display device (FIGS. 21 and 23) which requires three switching transistors to maintain the electric charge.

The device allows for scaling down of pixel size and is at the same time capable of compensating for the threshold voltage of the driver transistor. Therefore, more pixels are accommodatable in a predetermined screen size. Therefore, the display device of the present invention provides improved display quality.

### BRIEF DESCRIPTION OF DRAWINGS

FIG. 1 A circuit diagram illustrating a pixel circuit structure for a display device of embodiment 1 of the present invention.

FIG. 2 A block diagram illustrating the structure of a display device which is common to embodiments 1 to 3 of the present invention.

FIG. 3 A timing chart illustrating potential changes on wires in the pixel circuit shown in FIG. 1.

FIG. 4 A graph representing results of simulation of changes in the gate voltage, drain voltage, and source-to-drain current of a driver transistor in the pixel circuit shown in FIG. 1.

FIG. 5 A circuit diagram illustrating a pixel circuit structure as a comparative example for embodiment 1 of the present invention.

FIG. 6 A timing chart illustrating potential changes on wires in the pixel circuit shown in FIG. 5.

FIG. 7 A graph representing results of simulation of changes in the gate voltage, drain voltage, and source-to-drain current of a driver transistor in the pixel circuit shown in FIG. 5.

FIG. 8 A circuit diagram illustrating a pixel circuit structure as a comparative example for the pixel circuit of embodiment 2 of the present invention.

FIG. 9 A timing chart illustrating potential changes on wires in the pixel circuit shown in FIG. 8.

FIG. 10 A circuit diagram illustrating a pixel circuit structure for embodiment 3 of the present invention.

FIG. 11 A timing chart illustrating potential changes on wires in the pixel circuit shown in FIG. 10.

FIG. 12 A graph representing results of simulation of changes in the gate voltage, drain voltage, and source-to-drain current of a driver transistor in the pixel circuit shown in FIG. 10.

FIG. 13 A block diagram illustrating the structure of a display device which is common to embodiments 4 to 6 of the present invention.

FIG. 14 A circuit diagram illustrating a pixel circuit structure for embodiment 4 of the present invention.

FIG. 15 A timing chart illustrating potential changes on wires in the pixel circuit of embodiments 4 to 6 of the present invention.

FIG. 16 A graph representing results of simulation of changes in the gate voltage, drain voltage, and source-to-drain current of a driver transistor in the pixel circuit shown in FIG. 14.

FIG. 17 A circuit diagram illustrating a pixel circuit structure for embodiment 5 of the present invention.

FIG. 18 A graph representing results of simulation of changes in the gate voltage, drain voltage, and source-to-drain current of a driver transistor in the pixel circuit shown in FIG. 17.

FIG. 19 A circuit diagram illustrating a pixel circuit structure for embodiment 6 of the present invention.

FIG. 20 A graph representing results of simulation of changes in the gate voltage, drain voltage, and source-to-drain current of a driver transistor in the pixel circuit shown in FIG. 19.

FIG. 21 A circuit diagram illustrating a pixel circuit structure for a conventional display device.

FIG. 22 A timing chart illustrating the operation of the pixel circuit shown in FIG. 21.

FIG. 23 A circuit diagram illustrating a pixel circuit structure for another conventional display device.

FIG. 24 A timing chart illustrating the operation of the pixel circuit shown in FIG. 23.

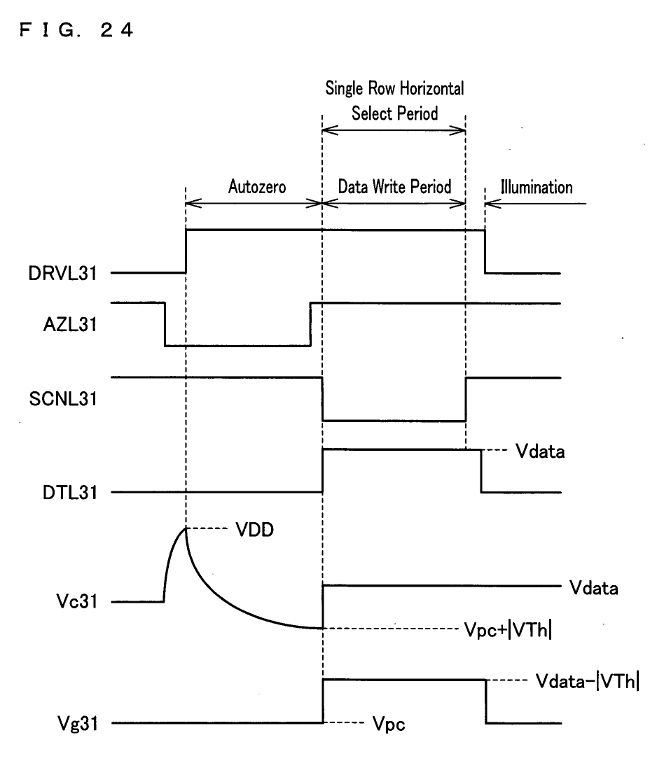

### BEST MODE FOR CARRYING OUT INVENTION

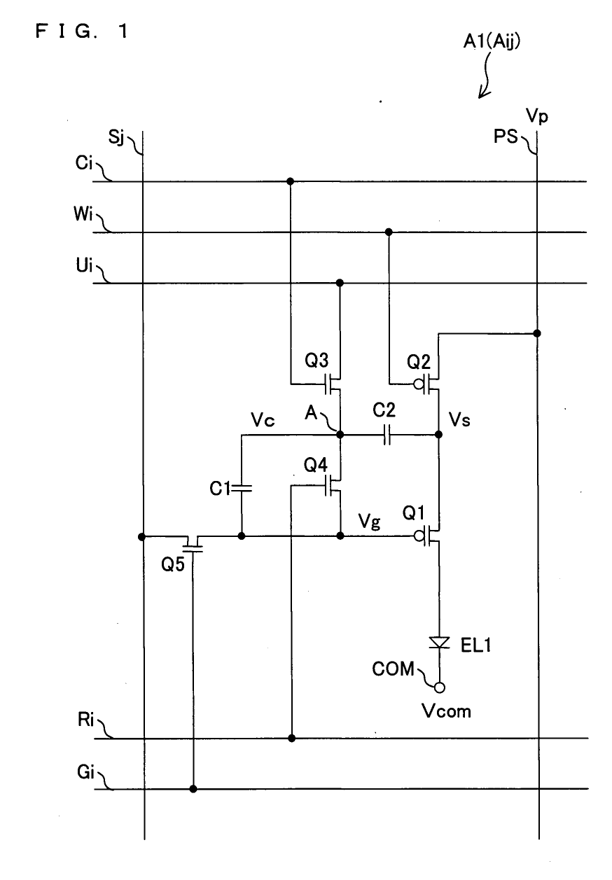

The following will describe embodiments of the present invention in reference to FIGS. 1 to 20.

The switching elements used in the present invention may be low-temperature polysilicon TFTs or CG (continuous grain) silicon TFTs, to name a few examples. They are CG silicon TFTs throughout the embodiments.

The structure of the CG silicon TFT is documented, for example, in “4.0-in. TFT-OLED Displays and a Novel Digital Driving Method” (SID '00 DIGEST, pp. 924-927, Semiconductor Energy Laboratory). A process of manufacturing CG silicon TFTs is documented, for example, in “Continuous Grain Silicon Technology and its Applications for Active Matrix Display” (AM-LCD 2000, pp. 25-28, Semiconductor Energy Laboratory). Since both the structure of the CG silicon TFT and its manufacturing process are publicly known, no detailed description will be given.

The structure of the OLED (electro-optical element used in the embodiments) is documented, for example, in “Polymer Light-Emitting Diodes for Use in Flat Panel Display” (AM-LCD '01, pp. 211-214, Semiconductor Energy Laboratory), publicly known. No detailed description will be given.

### Embodiment 1

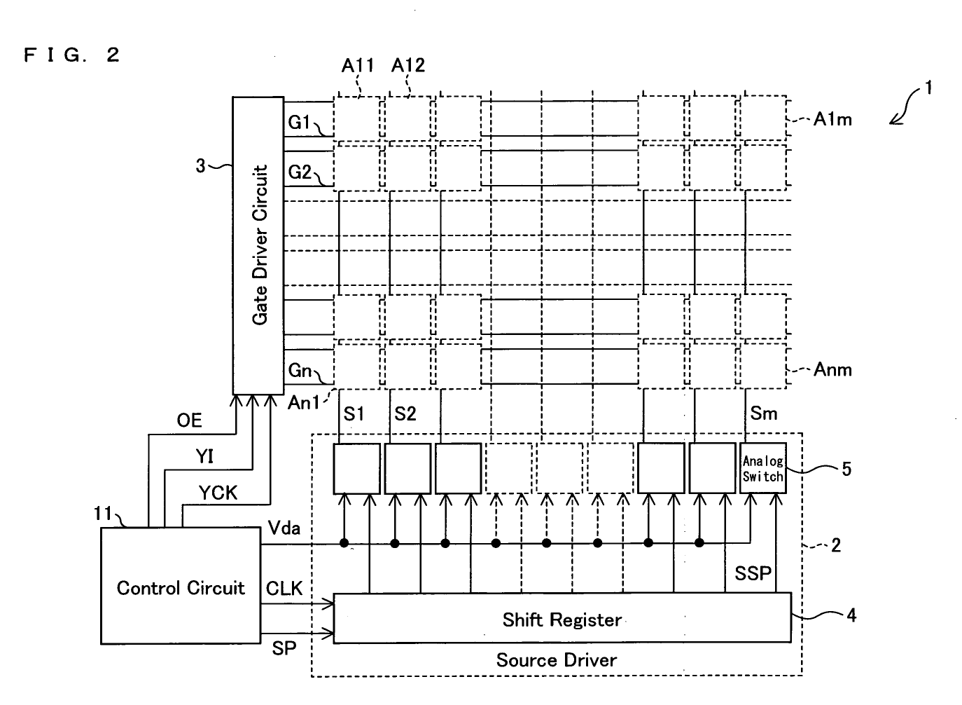

FIG. 1 is a circuit diagram illustrating the structure of a pixel circuit A1 in a display device 1 of the present embodiment. FIG. 2 depicts in a block diagram the overall circuit structure of the display device 1 of the present embodiment.

The display device 1 includes pixel circuits Aij (i=1 to n; j=1 to m), a source driver circuit 2, a gate driver circuit 3, and a control circuit 11 as shown in FIG. 2. The display device 1 further includes source lines Sj (signal lines), positioned parallel to one another, and gate lines Gi, positioned parallel to one another and orthogonal to the source lines Sj. The pixel circuit (pixels) Aij are each located where a source line Sj intersects a gate line Gi, forming a matrix as a whole. The source lines Sj are connected to the source driver circuit 2 to supply signals to the OLEDs EL1 (FIG. 1; will be detailed later). The gate lines Gi are connected to the gate driver circuit 3.

The driver circuits 2, 3 are preferably entirely or partially formed from polycrystalline silicon TFTs or CG silicon TFTs on the same substrate as the pixel circuit Aij to enable a compact overall size for the display device 1 and low fabrication cost.

The source driver circuit 2 includes an m-bit shift register 4 and m analog switches 5.

In the source driver circuit 2, the shift register 4 has m cascaded registers. A start pulse SP is fed from the control circuit 11 to the first stage, shifted in response to an incoming clock CLK, and output from the output stages (registers) to the associated analog switches 5 as timing pulses SSP. One analog switch 5 is provided to each source line Sj. The analog switch 5 opens after passing an input signal voltage Da on to the associated source line Sj.

As outlined above, the source driver circuit 2 has a structure similar to that of a source driver circuit used, for example, in polysilicon TFT liquid crystal displays.

The control circuit 11 outputs the start pulse SP, the clock CLK, and the signal voltage Da. The control circuit 11 outputs also a timing signal OE, a start pulse YI, and a clock YCK to the gate driver circuit 3.

The gate driver circuit 3 includes a shift register, a logic operation circuit, and a buffer (none shown). In the gate driver circuit 3, an incoming start pulse YI is shifted in the shift register in response to a clock YCK. The pulse outputs from the output stages of the shift register are subjected to a logic operation with a timing signal OE in the logic operation circuit. Necessary voltages are output through the buffer to the associated gate lines Gi and control lines Ri, Ci, Wi (detailed later).

Referring to FIG. 1, the pixel circuit A1 (Aij) has transistors (TFTs) Q1 to Q5, capacitors C1, C2, and an OLED (organic light emitting diode) EL1.

In the pixel circuit A1, the transistor (driver transistor) Q1 and the transistor (third switching transistor) Q2 are connected in series between a power supply line PS and the OLED EL1. The transistor Q1 is a driver transistor which supplies a drive current to the OLED EL1. A power supply voltage Vp is applied to the power supply line PS. A common potential Vcom is applied to a common cathode (common electrode) COM provided commonly to all the OLEDs EL1.

The capacitor (first capacitor) C1 and the capacitor (second capacitor) C2 are provided in series between the gate (current control terminal) and source (first current input/output terminal) of the transistor Q1. The contact of the capacitors C1, C2 will be referred to as contact A.

The switching transistor (first switching transistor) Q5 is provided between the gate of the transistor Q1 and the source line Sj. The switching transistor (second switching transistor) Q3 is provided between contact A and a potential line Ui. The switching transistor (fourth switching transistor) Q4 is provided in parallel with the capacitor C1.

The pixel circuit A1 employs the first current input/output control means to control the current input or output of the transistor Q1. The source of the transistor Q1 is connected to the drain (first current input/output terminal) of the transistor Q2 in this current input/output control means.

Preferably employed as a first potential control means is a structure where the transistor Q4 is provided in parallel with the capacitor C1 as mentioned above, to change the gate potential of the transistor Q1.

The transistors Q1, Q2 are p-type TFTs, and the transistors Q3 to Q5 are n-type TFTs in the pixel circuit A1.

The gates of the switching transistors Q2 to Q5 are connected respectively to the control lines Wi, Ci, Ri and the gate line Gi.

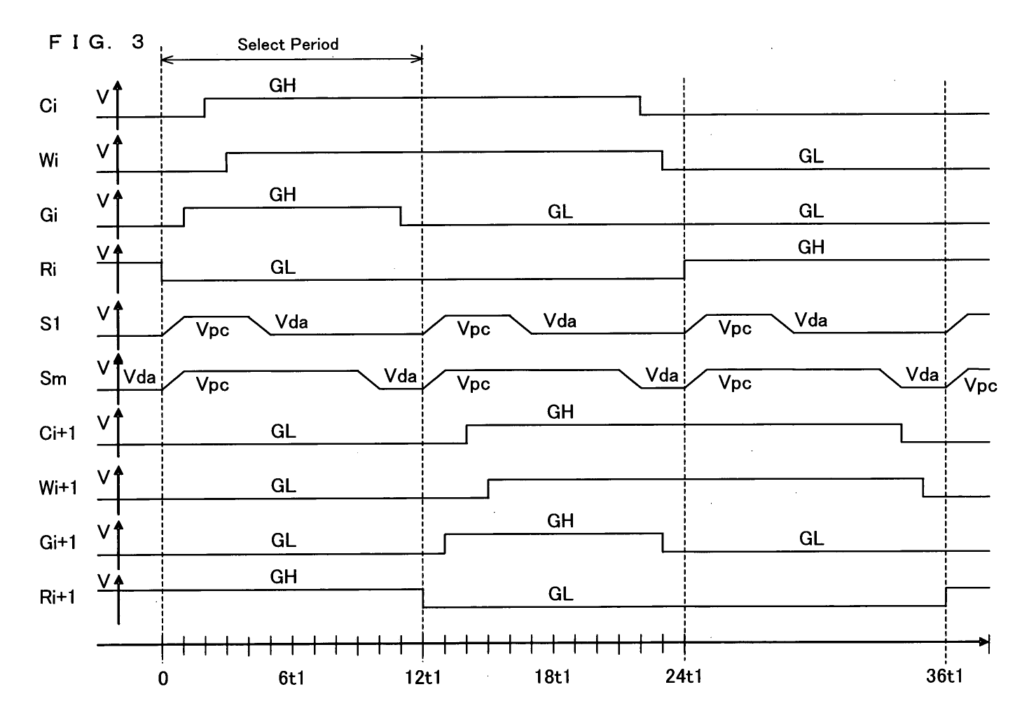

FIG. 3 is a timing chart illustrating the operation of the pixel circuit A1. The operation of the pixel circuit A1 is controlled by the source driver 2 and the gate driver 3 in accordance with the aforementioned various signals supplied from the control circuit 11. The following will describe the operation of the pixel circuit A1 in reference to the timing chart in FIG. 3.

FIG. 3 shows timings of changes in the voltages applied to the control line Ci, the control line Wi, the gate line Gi, the control line Ri, the source line S1, and the source line Sm. The control line Ci+1, the control line Wi+1, the gate line Gi+1, and the control line Ri+1 are connected to the same source line Sj and associated with the pixel circuit A(i+1)j connected to the gate line Gi+1 that is scanned following the gate line Gi.

A period from 0 to 12t1 is a select period for the pixel circuit Aij as shown in FIG. 3. First, the control line Ri is set to GL (LOW) at the onset of the select period, or at time 0, turning off the transistor Q4 to isolate contact A from the gate of the transistor Q1. A reset potential Vpc is applied to the source lines S1 to Sm through analog switches (not shown). The analog switches are provided between the source lines S1 to Sm and the reset voltage Vpc. They supply the reset voltage Vpc to the source lines S1 to Sm when they are closed.

The gate line Gi is set to GH (HIGH) at time 1t1, turning on the transistor Q5. That sets the gate of the transistor Q1 to the reset potential Vpc, which is the potential of the source line Sj. The transistor Q1 is therefore turned off.

The control line Ci is set to GH at time 2t1, turning on the transistor Q3. That connects contact A between the capacitors C1, C2 to the potential line Ui. Note that the potential of the potential line Ui is denoted by Va. The period from 1t1 to 2t1 detailed above is the first period.

The control line Wi is set to GH at time 3t1, turning off the transistor Q2. The transistor Q1 remains turned off. The capacitor C2 holds a potential difference Vp−Va (Vp>Va).

The timing pulses SSP are fed to the analog switches 5 over the period 4t1 to 10t1 to output the incoming signal voltages Vda to the associated source lines S1 to Sm, thereby setting the gates of the transistors Q1 to the potentials Vda. The capacitors C1 hold the potential differences Vda−Va.

The gate line Gi is set to GL at time 11t1, turning off the transistor Q5. Thus, the gate of the transistor Q1 is held at potential Vda by the capacitor C1.

Thereafter, since the gate of the transistor Q1 is held at Vda, the source potential of the transistor Q1 converges to a potential Vda+|Vth| (Vth is the threshold voltage) if the transistor Q1 turns on at that gate potential Vda. Accordingly, a threshold voltage develops between the gate and source of the transistor Q1. The period from 3t1 to 11t1 detailed above is the second period.

It would be no problem if the converging needs a few select periods, because the capacitor C1 holds the gate of the transistor Q1 at potential Vda. In addition, since contact A is connected to the potential line Ui via the transistor Q3, the capacitor C1 maintains its potential Vda if the source potential of the transistor Q1 changes.

As described above, by using of the pixel circuit A1 of the present embodiment, the gate potential of the transistor Q1 is maintained for a sufficiently long period after it changes to the data potential Vda. Accordingly, the potential difference Va−(Vda+|Vth|), which is associated with the threshold Vth of the transistor Q1, is maintained across the capacitor C2.

In addition, the control line Ci is set to GL at time 22t1, turning off the transistor Q3 to disconnect contact A from the potential line Ui. Thereafter, the control line Wi is set to GL at time 23t1, bringing the potential of the control line Ri to GH at time 24t1. The period from 22t1 to 24t1 detailed above is the third period.

Thus, the transistors Q2, Q4 are turned on. The capacitor C1 discharges via the ON transistor Q4. That brings the gate of the transistor Q1 at the same potential as contact A. In addition, as the transistor Q2 turns on, the voltage Vp is applied to the source of the transistor Q1. As a result, the gate of the transistor Q1 changes to Va−(Vda+|Vth|)+Vp.

That means that the gate-to-source voltage of the transistor Q1 equals Va−Vda−|Vth|. If the signal voltage Vda, applied earlier to the gate of the transistor Q1, is higher than the potential Va of the potential line Ui, the transistor Q1 is turned on. If the signal voltage Vda is the same as or lower than the potential Va, the transistor Q1 is turned off.

If the drain-to-source voltage Vds of the ON transistor Q1 is higher than the gate-to-source voltage Vgs, the current flow through the transistor Q1 saturates. Accordingly, the current Ids through the transistor Q1 is given by the following equation.

$$\begin{matrix}Ids = ( W \times μ \times Co / ( 2 \times L ) ) {( Vgs + \vert Vth \vert )}^{2} \\ = ( W \times μ \times Co / ( 2 \times L ) ) {( Va - Vda )}^{2}\end{matrix}$$

where W is the gate width of the TFT, L is the gate length of the TFT, μ is the TFT mobility, and Co is a constant. The equation demonstrates that the gate-to-source voltage of the transistor Q1 is compensated for the threshold voltage Vth of the transistor Q1.

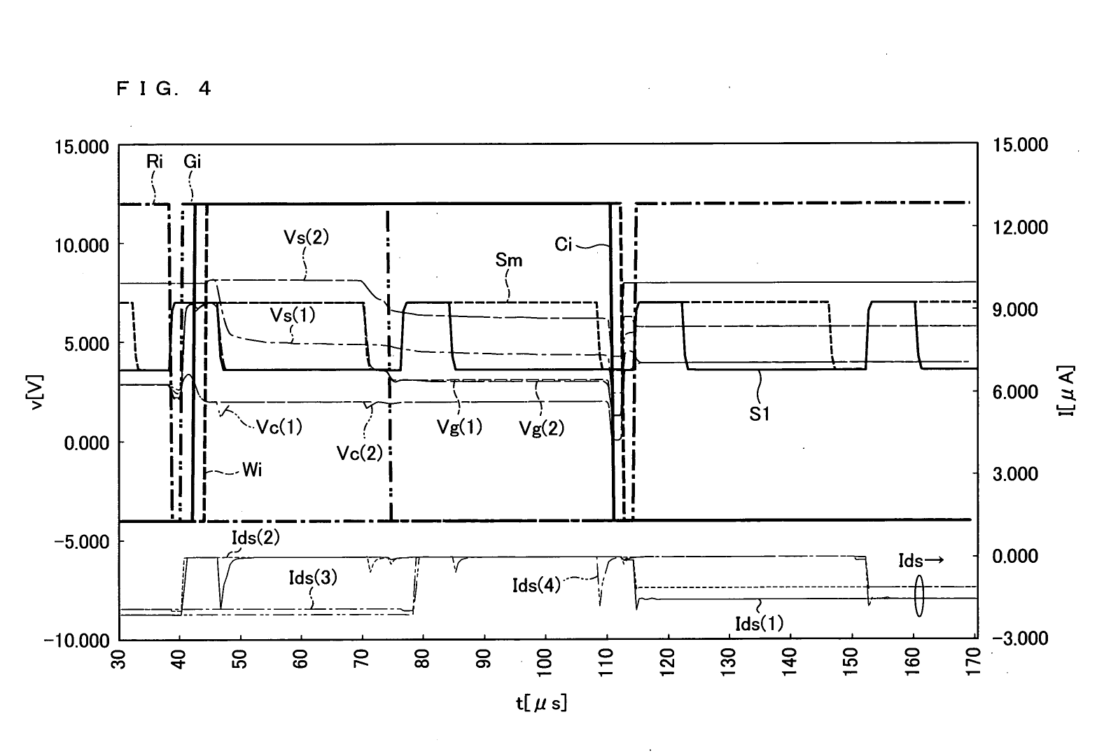

FIG. 4 shows results of simulation of the current Ids in the pixel circuit Aij based on properties of an OLED (GL=−4 V, GH=12 V, Vcom=0 V, Vp=10 V, Vpc=7 V, Va=4 V, Vda=3.2 V).

In FIG. 4, the current Ids(1) is a current flow through the pixel circuit Ai1 and corresponds to a case where the absolute value of the threshold voltage Vth of the transistor Q1 is a minimum (=Vth(min)) and the mobility μ is a maximum. The current Ids(2) is a current flow through the pixel circuit Aim and corresponds to a case where the absolute value of the threshold voltage Vth of the transistor Q1 is a maximum (=Vth(max)) and the mobility μ is a minimum. The current Ids(3) is a current flow through the pixel circuit A(i+1)1 and corresponds to a case where the absolute value of the threshold voltage Vth of the transistor Q1 is a maximum (=Vth(max)) and the mobility μ is a minimum. The current Ids(4) is a current flow through the pixel circuit A(i+1)m and corresponds to a case where the absolute value of the threshold voltage Vth of the transistor Q1 is a minimum (=Vth(min)) and the mobility μ is a maximum.

From the results of the simulation in FIG. 4, Ids(1)≈−1.55 μA, Ids(2)≈−1.13 μA, Ids(3)≈−1.13 μA, and Ids(4)≈−1.53 μA.

FIG. 4 demonstrates that substantially the same threshold compensation is performed in the pixel circuit Ai1 and in the pixel circuit Aim. Variations in the current Ids change with variations in the mobility μ of the transistor Q1.

In the case of the pixel circuit A1, it is the stray capacitance of the source line Sj and the capacitance of the capacitor C1 in the pixel circuit A1 that should be charged by the signal voltage Vda. In the case of a low-temperature polysilicon LCD, it is again the stray capacitance of the source line Sj, the liquid crystal in the pixel circuit Aij, and the capacitance of a voltage-holding capacitor that should be charged by the signal voltage Vda.

Therefore, if the pixel circuit A1 is used, a controller IC that is intended for use with liquid crystal is useable on its own.

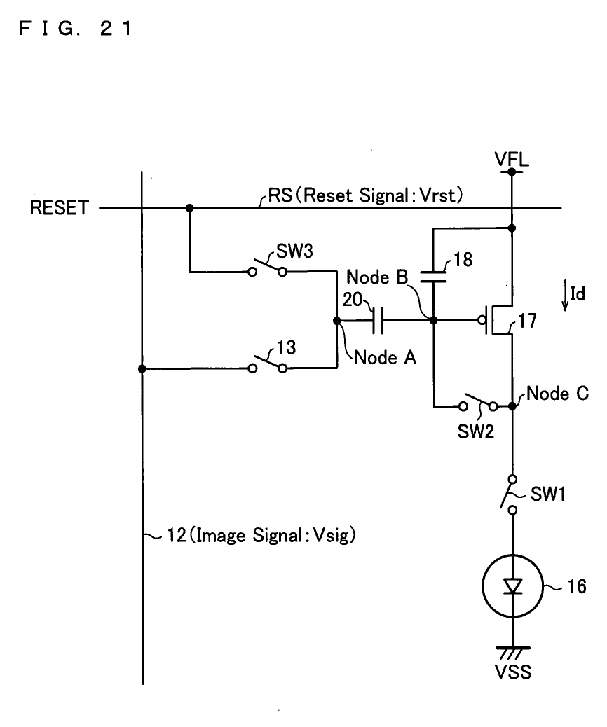

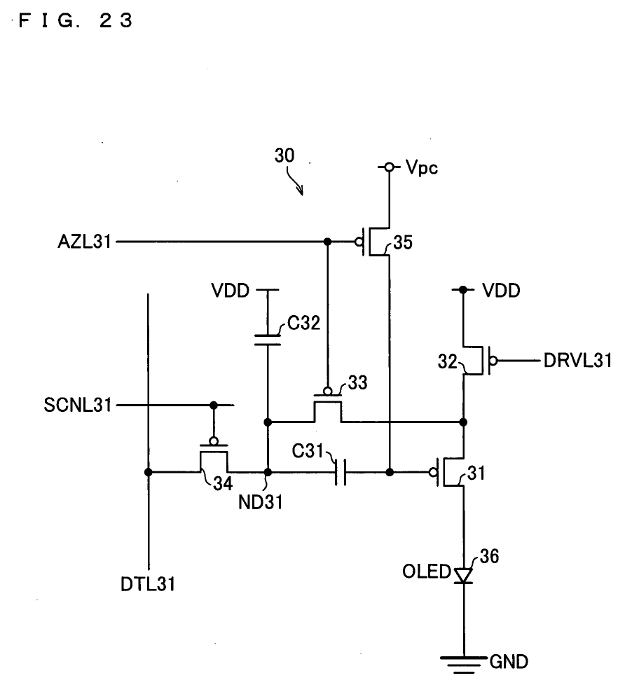

In addition, no devices other than the transistors Q3, Q5 are needed to hold the gate potential of the transistor Q1. Therefore, the pixel circuit Aij does not need as many TFTs each of which includes two series LDD (lightly doped drain) TFTs as in conventional art shown in FIGS. 21 and 23. That translates into a reduced number of elements making up a screen and a reduced pixel size (albeit by a small factor). Thus, more pixels are accommodatable in a predetermined screen size, which in turn improves image quality.

The transistor Q4 does not need to be formed from LDD TFTs for the following reasons.

The gate of the transistor Q4 is connected to the control line Ri. The potential of the control line Ri changes as shown in FIG. 3. The transistor Q4 is turned off for a plurality of select periods when the control line Ri is GL (0 to 24t1, which covers two select periods, in FIG. 3). Somewhat large off leak current from a TFT that is turned off for two or more select periods as in this example does not pose any problems. The transistor Q4 therefore does not need to have a double-gated LDD structure (TFTs with low off leak current).

Meanwhile, the control line Ci and the gate line Gi applies voltage to the gates of the transistors Q3, Q5. The potentials of the lines Ci, Gi change as shown in FIG. 3. It is one frame period, minus a few select periods, (from 0 to 24t1 in FIG. 3) when both lines Ci, Gi are GL. Accordingly, it is substantially one frame period when the transistors Q3, Q5 are off. If a large off leak current emanates from the TFT, the potential cannot be maintained. That necessitates a double-gated LDD structure (TFTs with low off leak current).

Therefore, those TFTs which should have a double-gated LDD structure are those connected to a capacitor and required to remain turned off over a long period (e.g., one field period or one frame period).

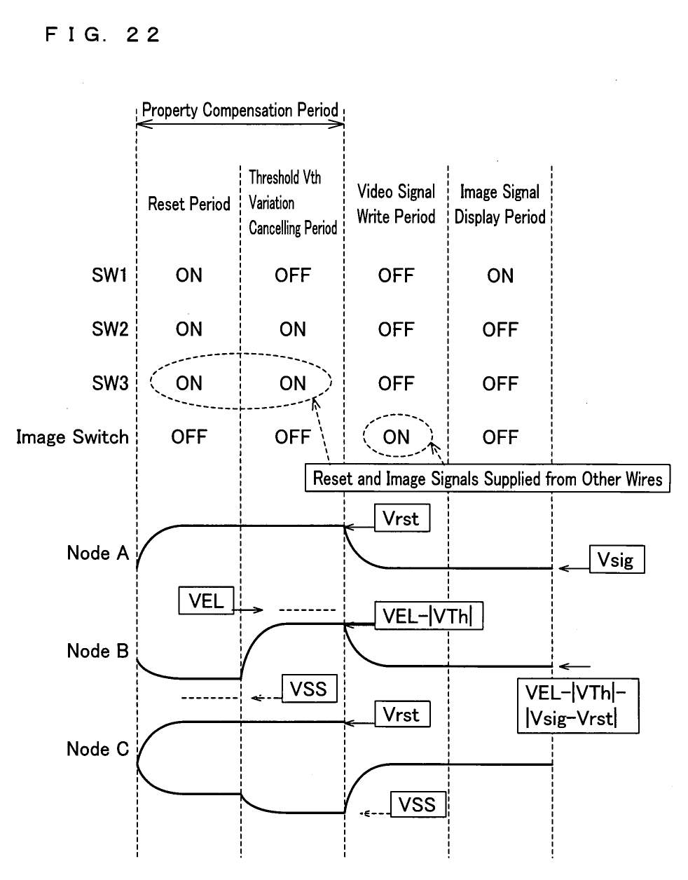

The number of elements making up a screen can be reduced, allowing for pixel size reduction (albeit small), in the conventional pixel circuit shown in FIG. 22 by modifications to the circuit structure. For example, in that conventional pixel circuit, one can connect one of the terminals of the capacitor 20 to the drain, rather than the gate, of the driver TFT 17. Accordingly, the switch SW2 can be omitted which is formed from LDD TFTs.

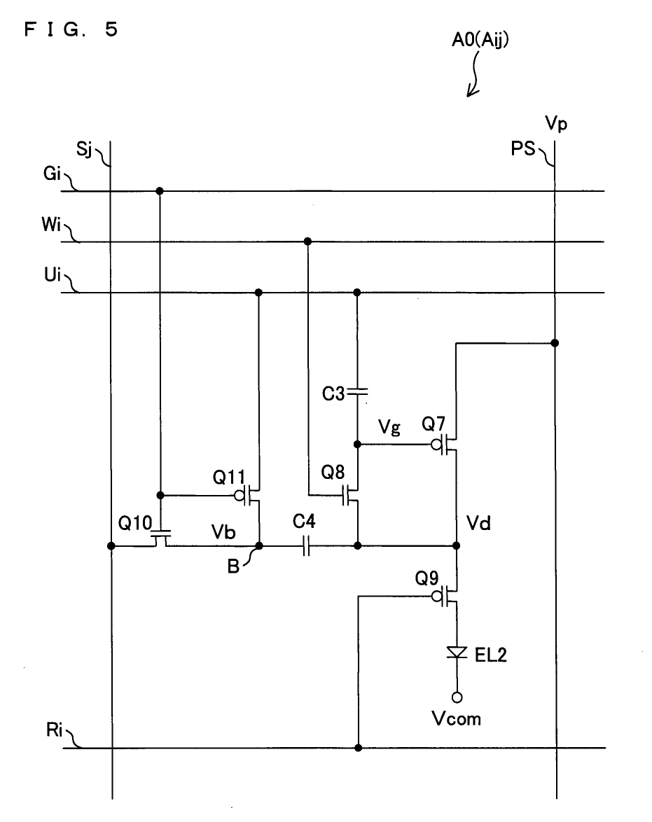

FIG. 5 shows a pixel circuit structure as a comparative example for the pixel circuit A1 of the present embodiment.

The pixel circuit A0 (Aij) shown in FIG. 5 includes transistors (TFTs) Q7 to Q11, capacitors C3, C4, and an OLED (electro-optical element) EL2.

The transistors Q7 to Q11 are the equivalents to the TFT 17, the switches SW2, SW1, the pixel switch 13, and the switch SW3, respectively, in FIG. 22. The OLED EL2 and the capacitors C3, C4 are the equivalents of the OLED 16 and the capacitors 18, 20, respectively, in FIG. 22. In the pixel circuit A0, the capacitor C4, unlike the capacitor 20, is connected at one of its terminals to the drain of the transistor Q7.

In this structure, the gate potential of the transistor Q7 does not change with the electric charge of the capacitor C4. The transistors Q10, Q11 can be formed from ordinary TFTs.

Still referring to the pixel circuit A0 in FIG. 5, the transistors Q7, Q9 are connected in series between the power supply line PS and the OLED EL2. The capacitor C3 is provided between the gate of the transistor Q7 and the potential line Ui. The transistor Q8 is provided between the gate and drain of the transistor Q7.

The capacitor C4 and the transistor Q10 are provided in series between the drain of the transistor Q7 and the source line Sj. The contact of the capacitor C4 and the transistor Q10 will be referred to as contact B. The transistor Q11 is provided between the contact B and the potential line Ui. The gates of the transistors Q8, Q9 are connected to the control lines Wi, Ri respectively. The gates of the transistors Q10, Q11 are connected to the gate line Gi.

The transistor Q7 and the transistors Q9, Q1 are p-type TFTs, and the transistors Q8, Q10 are n-type TFTs, in the pixel circuit A0 shown in FIG. 5.

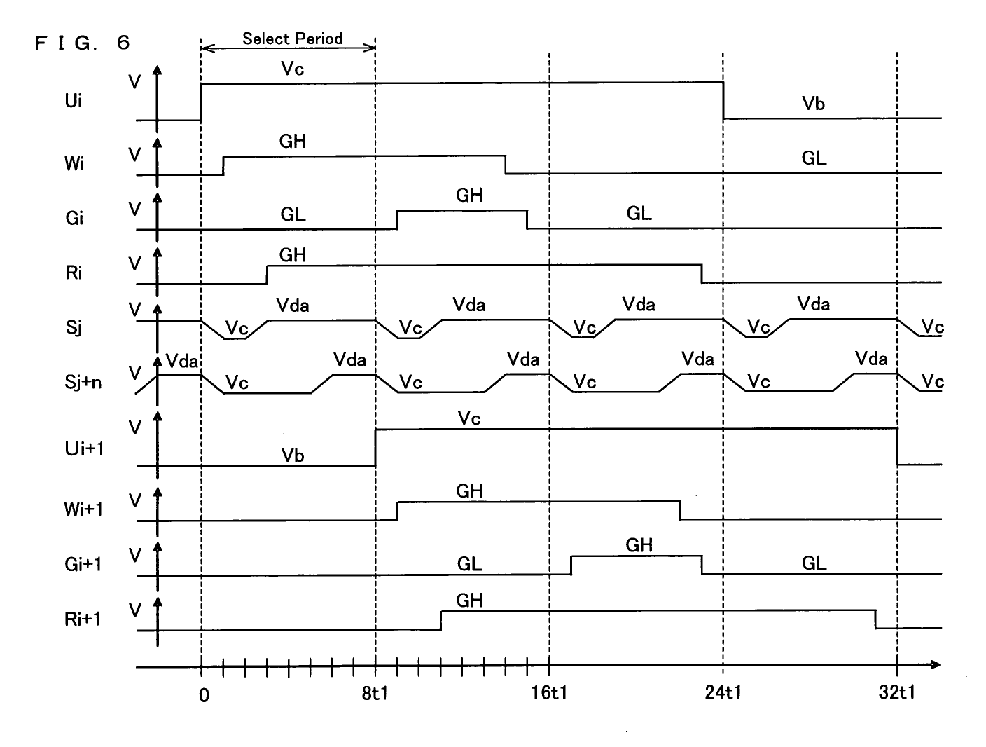

FIG. 6 is a timing chart illustrating the operation of the pixel circuit A0. The following will describe the operation of the pixel circuit A0 in reference to the chart.

FIG. 6 shows timings of changes in the voltages applied to the control line Ci, the control line Wi, the gate line Gi, the control line Ri, the source line S1, and the source line Sm. The control line Ci+1, the control line Wi+1, the gate line Gi+1, and the control line Ri+1 are connected to the same source line Sj and associated with the pixel circuit A0 that is connected to the gate line Gi+1 that is scanned following the gate line Gi.

A period from 8 to 16t1 is a select period for the pixel circuit A0 preceded by a threshold compensation period for the pixel circuit A0. In other words, at time 0, the potential line Ui is set to the potential Vc, turning off the transistor Q7.

The control line Wi is set to GH (HIGH) at time t1, turning on the transistor Q8. Then, since the control line Ri is GL (LOW), the transistor Q9 is on. Accordingly, the gate and drain of the transistor Q7 have the same potential Vg; the transistor Q7 turns on. At the same time, since the gate line Gi is GL (LOW), the transistor Q11 is on, allowing the potential line Ui to apply its potential Vc to the other terminal of the capacitor C4.

The control line Ri is set to GH at time 3t1, turning off the transistor Q9. That raises the drain potential of the transistor Q7, and when it reaches Vp−|Vth|, the transistor Q7 turns off.

The source line Sj is set to potential Vc at time 8t1, and the gate line Gi is set to GH at time 9t1. That turns off the transistor Q11 and turns on the transistor Q10. Meanwhile, the other terminal of the capacitor C4 is held at Vc.

The signal voltages Vda are applied to the source lines S1 to Sm over the period 10t1 to 13t1. The potential Vc is set in advance so that signal potential Vda>Vc.

Accordingly, the gate potential of the transistor Q7 can be changed without turning on the transistor Q7. Assuming that the capacitors C3, C4 have the same capacitance, the gate potential of the transistor Q7 is Vp−|Vth|+(Vda−Vc)/2.

The control line Wi is set to GL at time 14t1, turning off the transistor Q8. The capacitor C3 thus holds the gate potential of the transistor Q7.

The gate line Gi is set to GL at time 15t1, turning off the transistor Q10 and turning on the transistor Q11.

Thereafter, the control line Ri is set to GL at time 23t1, turning on the transistor Q9. In addition, the potential line Ui is set to Vb at time 24t1.

Under these conditions, if Vc−Vb>(Vda−Vc)/2, the gate potential of the transistor Q7 is an ON potential. On the other hand, if Vc−Vb≦(Vda−Vc)/2, the gate potential of the transistor Q7 is an OFF potential.

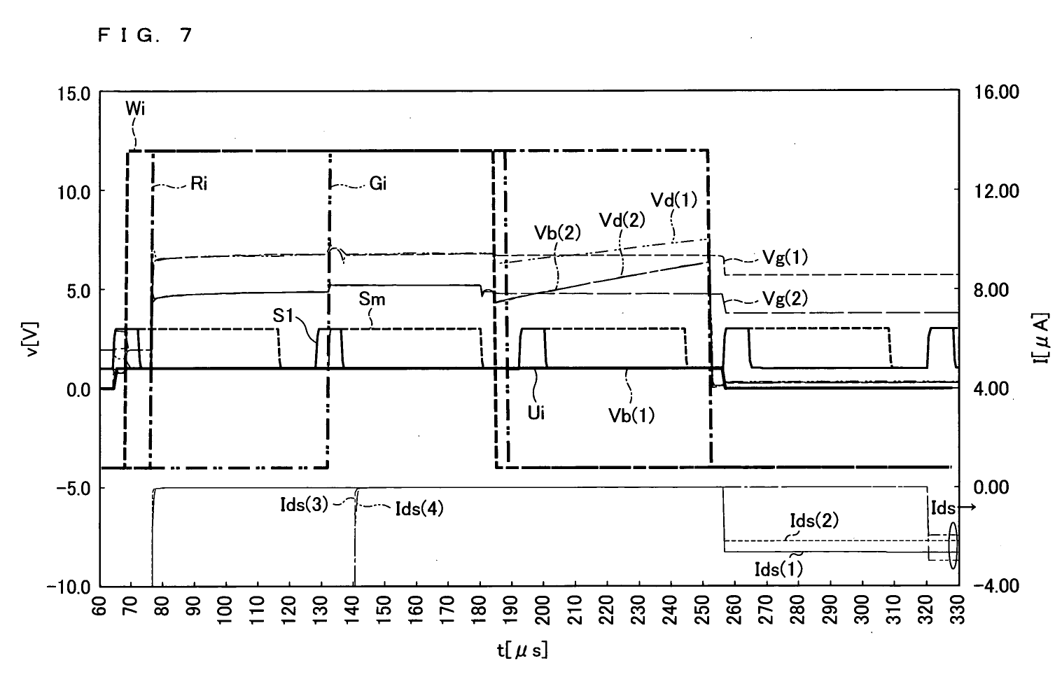

FIG. 7 shows results of simulation of the current Ids in the pixel circuit A0 in FIG. 5 based on properties of an OLED (GL=−4 V, GH=12 V, Vcom=0 V, Vp=10 V, Vc=1 V, Vb=0 V, Vda=3 V).

Using similar language as with the pixel circuit Aij of the present embodiment, in FIG. 7, the current Ids(1) is a current flow through the pixel circuit Ai1 and corresponds to a case where the absolute value of the threshold voltage Vth of the transistor Q7 is a minimum (=Vth(min)) and the mobility μ is a maximum. The current Ids(2) is a current flow through the pixel circuit Aim and corresponds to a case where the absolute value of the threshold voltage Vth of the transistor Q7 is a maximum (=Vth(max)) and the mobility μ is a minimum. The current Ids(3) is a current flow through the pixel circuit A(i+1)1 and corresponds to a case where the absolute value of the threshold voltage Vth of the transistor Q7 is a maximum (=Vth(max)) and the mobility μ is a minimum. The current Ids(4) is a current flow through the pixel circuit A(i+1)m and corresponds to a case where the absolute value of the threshold voltage Vth of the transistor Q7 is a minimum (=Vth(min)) and the mobility μ is a maximum.

From the results of the simulation in FIG. 7, Ids(1)≈−2.64 μA, Ids(2)≈−2.19 μA, Ids(3)≈−1.97 μA, and Ids(4)≈−2.98 μA.

In the pixel circuit structure in FIG. 5, if the leak current from the transistor Q8 is large, the capacitor C3 cannot hold its charge, failing to maintain the gate potential of the driver transistor Q7. Therefore, the transistor Q8 needs to have a double-gated LDD structure. In contrast, the gate potential of the driver transistor Q7 can be maintained even if the capacitor C4 cannot hold its charge. Therefore, the transistors Q10, Q11 do not need to have a double-gated LDD structure. As explained above, the pixel circuit structure in FIG. 5 is also capable of achieving the first objective of the present invention. Nevertheless, the current Ids in the pixel circuits Ai1 and Aim varies more in the pixel circuit structure in FIG. 5, as can be seen from a comparison of the simulation results in FIGS. 4 and 7 regarding the pixel circuit structure including the means of the present invention. For this reason, the pixel circuit in FIG. 5 cannot achieve the second objective of the present invention. This is presumably because it takes time for the gate potential of the transistor Q7 to change completely after the potential of the source line Sj has changed.

In contrast, the pixel circuit A1 of the present embodiment can wait until the gate potential of the transistor Q2 changes completely. As the simulation results in FIG. 4 indicate, the variations in the current Ids change only with variations in the mobility μ of the transistor Q1, thereby achieving good image quality.

### Embodiment 2

The pixel circuit structure in FIG. 1 described in embodiment 1 contains not only n-type TFTs, but also p-type TFTs. The present invention is applicable, however, to structures that involve only n-type TFTs, such as amorphous silicon TFTs. The present embodiment will focus on those pixel circuit structures.

The same display device 1 as the one shown in FIG. 2 is used in the present embodiment; its description will not be repeated. In addition, the same elements in the pixel circuit Aij as those in the pixel circuit A1 (FIG. 1) in embodiment 1 are identified by the same reference symbols and their description is hot repeated here.

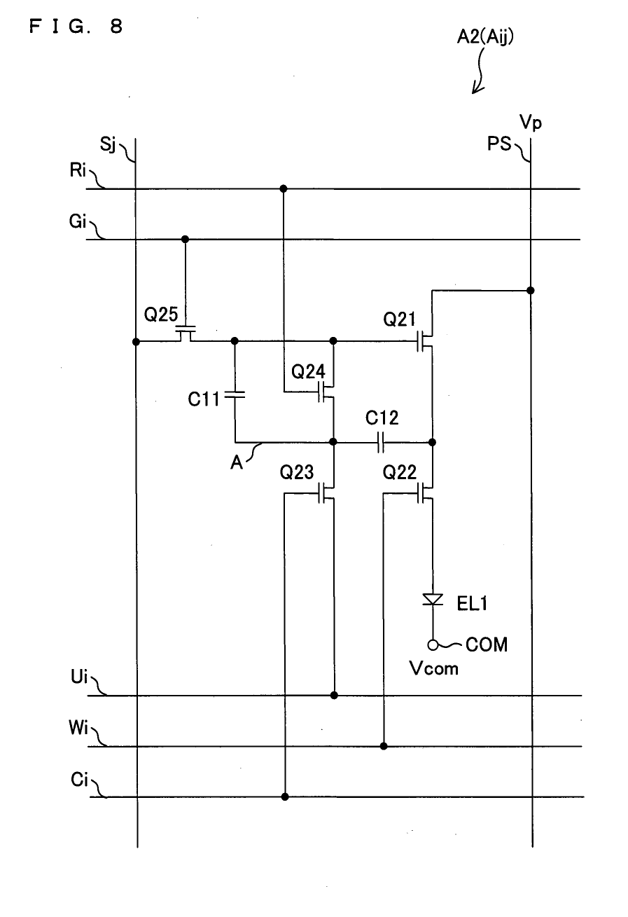

FIG. 8 is a circuit diagram illustrating the structure of a pixel circuit A2 (Aij) in the display device 1 of the present embodiment.

Referring to FIG. 8, the pixel circuit A2 has transistors (n-type TFTs) Q21 to Q25, capacitors C11, C12, and an OLED (electro-optical element) EL1.

In the pixel circuit A2, the transistor (driver transistor) Q21 and the transistor (third switching transistor) Q22 are connected in series between a power supply line PS and the OLED EL1. The transistor Q21 is a driver transistor which supplies a drive current to the OLED EL1.

The capacitor (first capacitor) C11 and the capacitor (second capacitor) C12 are provided in series between the gate (current control terminal) and source (first current input/output terminal) of the transistor Q21. The contact of the capacitors C11, C12 will be referred to as contact A.

The transistor (first switching transistor) Q25 is provided between the gate of the transistor Q21 and the source line Sj. The transistor (second switching transistor) Q23 is provided between contact A and the potential line Ui. The transistor (fourth switching transistor) Q24 is provided in parallel with the capacitor (first capacitor) C11.

In the pixel circuit A2, the gates of the switching transistors Q22 to Q25 are connected to the control lines Wi, Ci, Ri, and the gate line Gi respectively.

The pixel circuit A2 employs the first current input/output means to control the current input/output of the transistor Q21 too. The source (first current input/output terminal) of the transistor Q21 is connected to the drain (first current input/output terminal) of the transistor Q22 in this current input/output means.

Preferably employed as the first potential control means is a structure where the fourth switching transistor Q24 is provided in parallel with the capacitor C11 as mentioned above, to change the potential of the current control terminal of the transistor Q21.

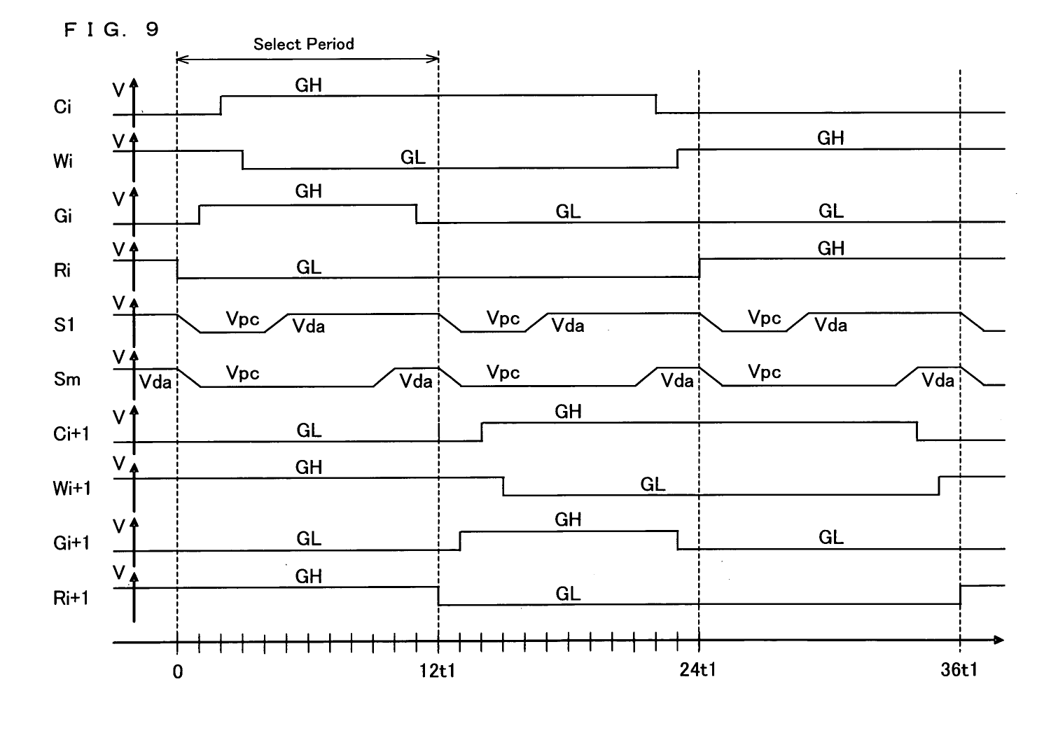

FIG. 9 is a timing chart illustrating the operation of the pixel circuit A2. The operation of the pixel circuit A2 is also controlled by the source driver 2 and the gate driver 3 in accordance with the aforementioned various signals supplied from the control circuit 11.

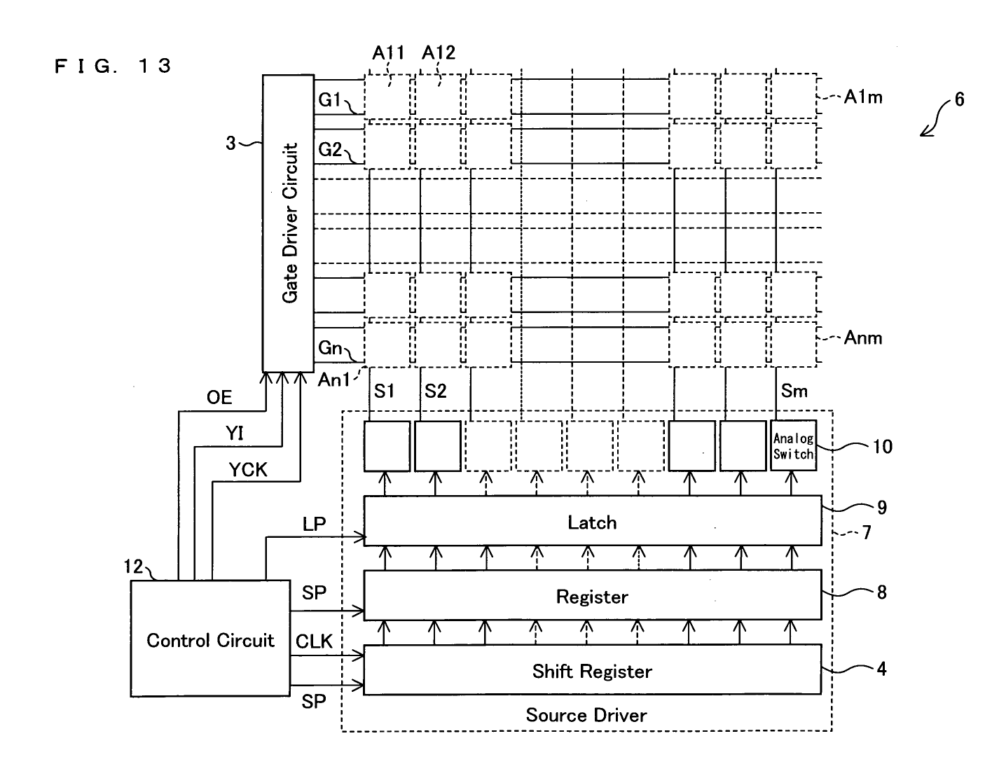

The following will describe the operation of the pixel circuit A2 in reference to the timing chart in FIG. 13.

FIG. 9 shows timings of changes in the voltages applied to the control line Ci, the control line Wi, the gate line Gi, the control line Ri, the source line S1, and the source line Sm. The lines Ci+1, Wi+1, Gi+1, Ri+1 are connected to the same source line Sj and associated with the pixel circuit A(i+1)j connected to the gate line Gi+1 that is scanned following the gate line Gi.

A period from 0 to 12t1 is a select period for the pixel circuit A2 as shown in FIG. 9. The control line Ri is set to GL (LOW) at the onset of the period, or at time 0, turning off the transistor Q24 to isolate contact A from the gate of the transistor Q21. A reset potential Vpc is applied to the source lines S1 to Sm through analog switches (switches connecting the source lines S1 to Sm to the reset voltage Vpc; not shown).

The gate line Gi is set to GH (HIGH) at time t1, turning on the transistor Q25. That sets the gate of the transistor Q21 to the reset potential Vpc, which is the potential of the source line Sj. The transistor Q21 is therefore turned off.

The control line Ci is set to GH at time 2t1, turning on the transistor Q23. That connects contact A for the capacitor C1 to the potential line Ui. Note that the potential of the potential line Ui is denoted by Va.

The control line Wi is set to GL at time 3t1, turning off the transistor Q22. The transistor Q21 remains turned off. The capacitor C12 holds a potential difference Vd−Va. Vd denotes the drain potential of the transistor Q21 and approximately equals Vcom.

The incoming signal voltages Vda are applied to the associated source lines S1 to Sm over the period 4t1 to 10t1. The signal voltages Vda are set up to such values that the transistors Q21 are turned on, thereby setting the gates of the transistors Q21 to the potentials Vda. The capacitors C11 hold the potential differences Vda−Va.

The gate line Gi is set to GL at time 11t1, turning off the transistor Q25. Thus, the gate of the transistor Q21 is held at potential Vda by the capacitor C11.

Thereafter, since the gate of the transistor Q21 is held at Vda, the source potential of the transistor Q21 converges to a potential Vda−Vth. The threshold voltage Vth of the transistor Q21 is positive; no absolute value is taken here.

It would be no problem if the converging needs a few select periods, because the capacitor C11 holds the gate of the transistor Q21 at potential Vda. In addition, since contact A is connected to the potential line Ui via the transistor Q23, the capacitor C11 maintains its potential Vda if the source potential of the transistor Q21 changes.

As described above, by using the pixel circuit A2 of the present embodiment, the gate potential of the transistor Q21 is maintained for a sufficiently long period after it changes to the data potential Vda. Accordingly, the potential difference Va−(Vda−Vth), which is associated with the threshold for the transistor Q21, is maintained across the capacitor C12.

In addition, the control line Ci is set to GL at time 22t1, turning off the transistor Q23 to disconnect contact A from the potential line Ui. Thereafter, the control line Wi is set to GH at time 23t1, bringing the potential of the control line Ri to GH.

Thus, the transistors Q22, Q24 are turned on. The capacitor C11 discharges via the ON transistor Q24. That brings the gate of the transistor Q11 at the same potential as contact A. Therefore, the gate-to-source voltage of the transistor Q21 is Va−(Vda−Vth).

If the signal voltage Vda, applied earlier to the gate of the transistor Q21, is lower than the potential Va of the potential line Ui, the transistor Q21 is turned on. If the signal voltage Vda is the same or higher than the potential Va, the transistor Q21 is turned off.

As discussed above, the present invention is still applicable when amorphous silicon TFTs are used and does not need as many TFTs each of which includes two series LDD (lightly doped drain) TFTs as in conventional art shown in FIGS. 22 and 23. That translates into a reduced number of elements making up a screen and a reduced pixel size (albeit by a small factor). Thus, more pixels are accommodatable in a predetermined screen size, which in turn improves image quality.

In addition, amorphous silicon TFTs require fewer masks and are therefore cheaper in the manufacture of large-scale display devices than CGS (continuous grain silicon) TFTs.

### Embodiment 3

The pixel circuit structures in embodiments 1, 2 (FIGS. 1, 8) needs five horizontal wires. Among them, the potential line Ui may be shared by the pixel circuits A (i−1)j, A(i+1)j connected respectively to the two gate lines Gi−1, Gi+1 that are adjacent to the gate line Gi. The gate line Gi and the control line Ri, Wi, Ci cannot be shared by the pixel circuits A (i−1)j, A(i+1)j.

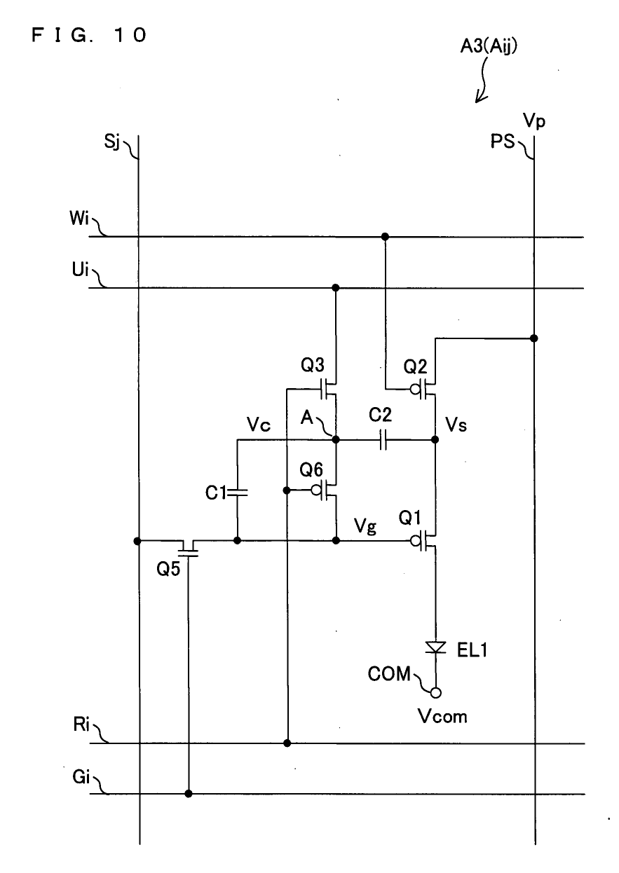

Accordingly, the present embodiment will describe a pixel circuit structure from which the control line Ci is omitted. FIG. 10 is a circuit diagram illustrating the structure of such a pixel circuit A3 (Aij).

Referring to FIG. 10, the pixel circuit A3 of the present embodiment replaces the n-type transistor Q4 in the pixel circuit A1 of embodiment 1 (FIG. 1) with a p-type transistor Q6, omits the control line Ci connected to the gate of the transistor Q3, and has the control line Ri connected to the gate of the transistor Q3. Otherwise, pixel circuit A3 is the same as the pixel circuit A1 in FIG. 1; the same description will not be repeated.

In addition, the same display device 1 as the one shown in FIG. 2 is used in the present embodiment; its description will not be repeated.

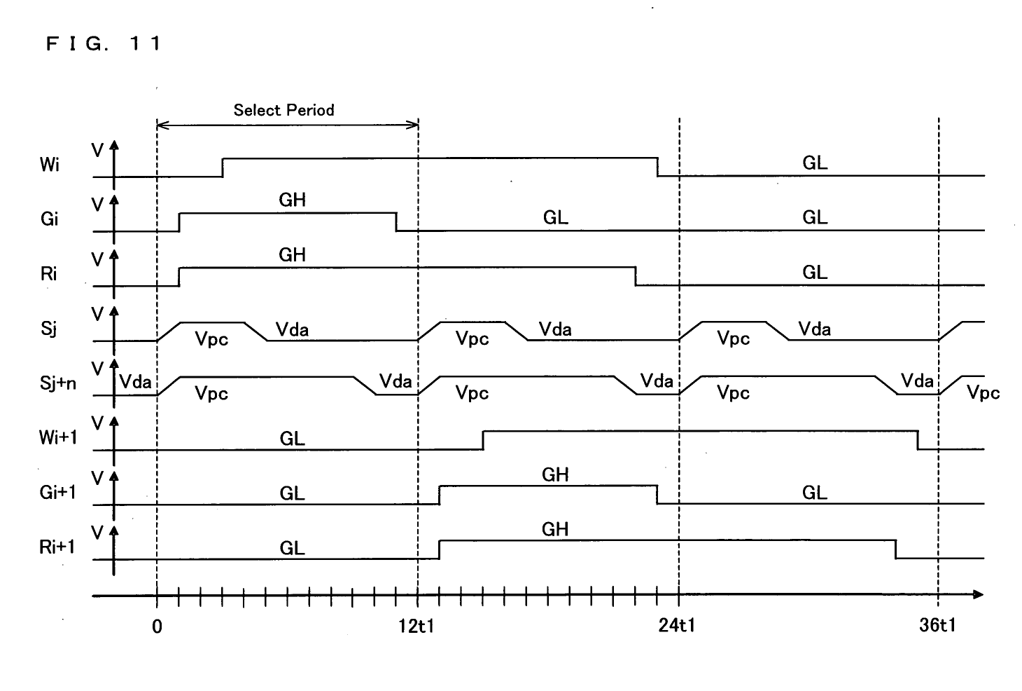

FIG. 11 is a timing chart illustrating the operation of the pixel circuit A3. The operation of the pixel circuit A3 is controlled by the source driver 2 and the gate driver 3 in accordance with the aforementioned various signals supplied from the control circuit 11. The following will describe the operation of the pixel circuit A3 in reference to the timing chart in FIG. 11.

FIG. 11 shows timings of changes in the voltages applied to the control line Wi, the gate line Gi, the control line Ri, the source line Si, and the source line Sm. The lines Wi+1, Gi+1, Ri+1 are connected to the same source line Sj and are associated with the pixel A(i+1)j connected to the gate line Gi+1 that is scanned following the gate line Gi.

A period from 0 to 12t1 is a select period for the pixel Aij as shown in FIG. 11. First, the reset potential Vpc is applied to the source lines S1 to Sm at the onset of the select period, or at time 0, through analog switches (switches connecting the source lines S1 to Sm to the reset voltage Vpc; not shown).

The control line Ri is set to GH (HIGH) at time t1, turning off the transistor Q6 and turning on the transistor Q3 to isolate contact A from the gate of the transistor Q1. In addition, contact A, on one of the terminals of the capacitor C2, is connected to the potential line Ui. Note that the potential of the potential line Ui is denoted by Va.

The gate line Gi is set to GH (HIGH) at time t1, turning on the transistor Q5. That sets the gate of the transistor Q1 to the reset potential Vpc, which is the potential of the source line Sj. The gate of the transistor Q1 is held at the reset potential Vpc. The transistor Q1 is later turned off.

The control line Wi is set to GH at time 3t1, turning off the transistor Q2. Then, since the transistor Q1 is off, the capacitor C2 is holding a potential difference Vp−Va.

The timing pulses SSP are fed to the analog switches 5 over the period 4t1 to 10t1 to output the incoming signal voltages Vda to the associated source lines S1 to Sm. That sets the gate of the transistor Q1 to the potential Vda. In addition, the capacitor C1 holds a potential difference Vda−Va.

The gate line Gi is set to GL at time 1t1, turning off the transistor Q5. Accordingly, the capacitor C1 holds the gate potential Vda of the transistor Q1.

Thereafter, since the gate of the transistor Q1 is held at Vda, the source potential of the transistor Q1 converges to a potential Vda+|Vth| (Vth is the threshold voltage). The control line Ri is set to GL at time 22t1, turning off the transistor Q3 and turning on the transistor Q6. Preferably, the transistor Q6 is turned on after the transistor Q3 is turned off. One way of doing this is to provide the transistor Q3 near the control line Ri.

With the transistor being provided near the control line Ri and the transistor Q6 being provided further down the line, when the control line Ri changes from HIGH to LOW, the gate of the transistor Q3 changes from HIGH to LOW before the gate of the transistor Q6 changes from HIGH to LOW. This phenomenon is caused by signal transmission being slowed down by the wire resistance R and wire capacitance C of the control line Ri (it is also correct to understand that it takes to charge the wire capacitance C).

Therefore, the resistance of the wiring between the gates of the transistors Q3, Q6 is increased, and so is the capacitance between them. That ensures a short, but sufficient time (about a few hundred nanoseconds) for the gate of the transistor Q6 to go LOW after the gate of the transistor Q3 goes LOW.

Turning on the transistor Q6 after turning off the transistor Q3 enables the capacitor C1 to discharge while the capacitor C2 is holding its charge. As a result, the gate of the transistor Q1 is at the same potential as contact A.

Thereafter, the control line Wi is set to GL at time 23t1, turning on the transistor Q2. Thus, the voltage Vp is applied to the source of the transistor Q1. As a result, the gate-to-source potential of the transistor Q1 equals Va−(Vda+|Vth|).

After that, the pixel circuit Aij operates the same way as the one in FIG. 1. The description will not be repeated.

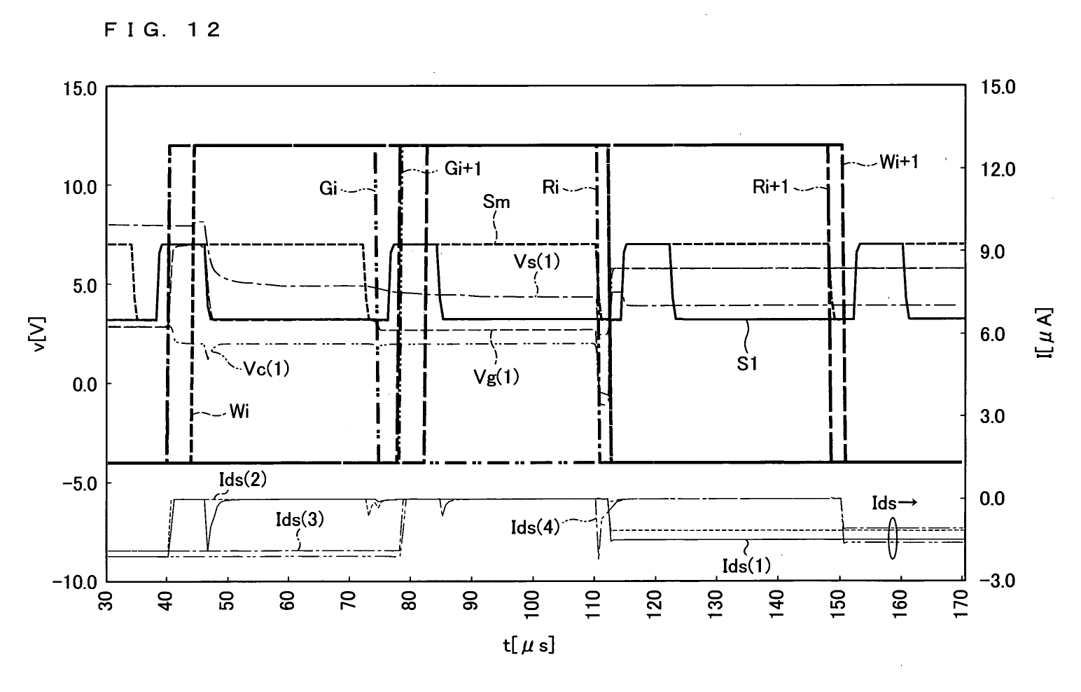

FIG. 12 shows results of simulation of the current Ids in the pixel circuit Aij based on properties of an OLED (GL=−4 V, GH=12 V, Vcom=0 V, Vp=10 V, Vpc=7 V, Va=4 V, Vda=3.2 V).

In FIG. 12, the current Ids(1) is a current flow through the pixel circuit Ai1 and corresponds to a case where the absolute value of the threshold voltage Vth of the transistor Q1 is a minimum (=Vth(min)) and the mobility μ is a maximum. The current Ids(2) is a current flow through the pixel circuit Aim and corresponds to a case where the absolute value of the threshold voltage Vth of the transistor Q1 is a maximum (=Vth(max)) and the mobility μ is a minimum. The current Ids(3) is a current flow through the pixel circuit A(i+1)1 and corresponds to a case where the absolute value of the threshold voltage Vth of the transistor Q1 is a maximum (=Vth(max)) and the mobility μ is a minimum. The current Ids(4) is a current flow through the pixel circuit A(i+1)m and corresponds to a case where the absolute value of the threshold voltage Vth of the transistor Q1 is a minimum (=Vth(min)) and the mobility μ is a maximum.

From the results of the simulation in FIG. 12, Ids(1)≈−1.50 μA, Ids(2)≈−1.17 μA, Ids(3) ≈−1.09 μA, and Ids(4) ≈−1.61 μA.

A comparison of the results of simulation in FIGS. 12 and 4 shows that variations are greater in FIG. 12. This is due to the momentary turn-on of the transistors Q3, Q6 at time 22t1 and accompanying changes in the charge stored by the capacitor C2 in the pixel circuit structure of FIG. 10.

Even considering these effects, the variations are still smaller than in the pixel circuit shown in FIG. 5. Obviously, the pixel circuit Aij of the present embodiment achieves the second objective of the present invention.

### Embodiment 4

The pixel circuit structure shown in FIG. 10 still needs five TFTs per pixel. To achieve the first objective of the present invention, the number of TFTs per pixel is preferably reduced.

Accordingly, the present embodiment will describe a structure which allows for a smaller number of TFTs per pixel.

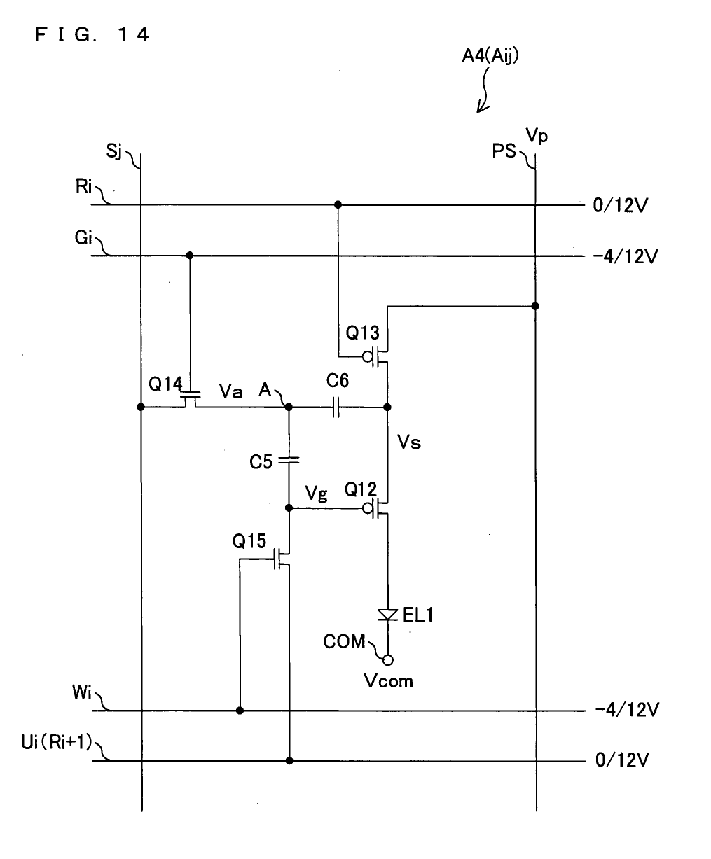

FIG. 13 depicts in a block diagram the overall circuit structure of a display device 1 of the present embodiment. FIG. 14 is a circuit diagram illustrating the structure of a pixel circuit A4 (Aij) in the display device 1 of the present embodiment.

A display device 6 of the present embodiment includes pixel circuits Aij, a gate driver circuit 3, and a source driver circuit 7, similarly to the display device 1 of embodiment 1 (see FIG. 2) as shown in. FIG. 13. The pixel circuits Aij are provided to form a matrix. The gate driver circuit 3 and the source driver circuit 7 controls the lines.

The driver circuits 2, 7 are preferably entirely or partially formed from polycrystalline silicon TFTs or CG silicon TFTs on the same substrate as the pixel circuit Aij to enable a compact overall size for the display device 6 and low fabrication cost.

The source driver circuit 7 includes an m-bit shift register 4, an m-bit register 8, an m-bit latch 9, and m analog switches 10.

In the source driver circuit 7, the shift register 4 has m cascaded registers. A start pulse SP is fed to the first stage, shifted in response to an incoming clock CLK from the control circuit 12, and output from the output stages (registers) to the associated input terminals of the register 8 as timing pulses SSP.

The register 8 holds incoming data Dx at the positions associated with the source lines Sj in response to the incoming timing pulses SSP from the shift register 4. The latch 9 reads in the m-bit data being held, in response to latch pulses LP and outputs them to the analog switches 10. The analog switches 10 select voltages corresponding to the incoming data Dx for output to the source lines Sj.

The display device 6 is assumed to receive 1-bit digital data as the data signal Dx.

The control circuit 12 outputs the data Dx instead of the aforementioned signal voltage Da. Otherwise, the control circuit 12 is the same as the control circuit 11, outputting the start pulse SP, the clock CLK, the timing signal OE, the start pulse YI, and the clock YCK.

The display device 6 produces a grayscale display by time division which the display device 6 in turn achieves by time multiplexing.

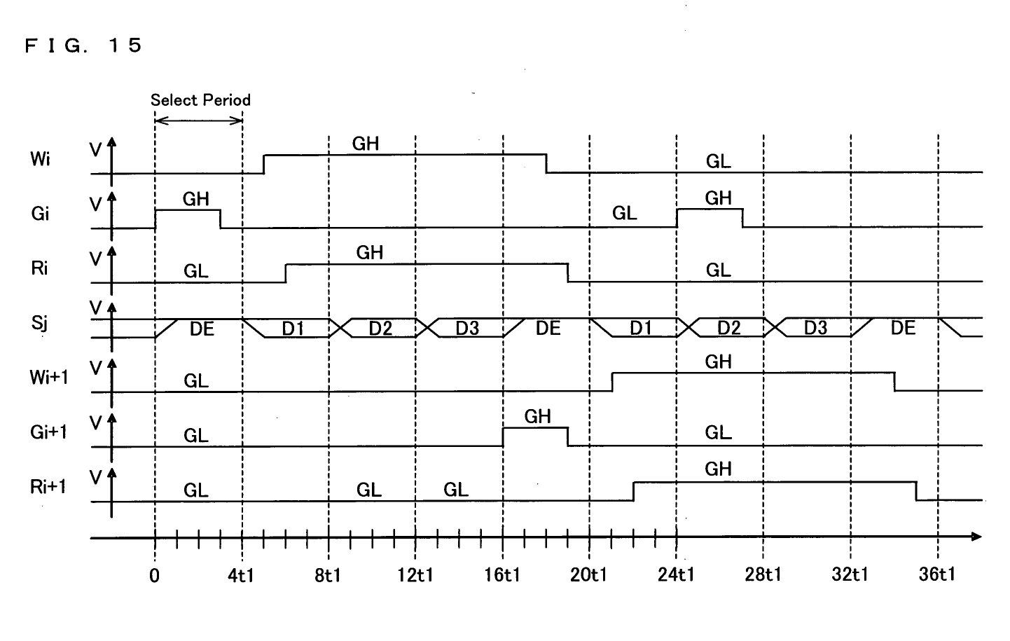

Specifically, in the case of the pixel circuit A4 producing a display from four-bit data, each frame period is divided into four subframe periods as shown in FIG. 15. Three of the subframe periods are assigned for three data sets D1 to D3, and the remaining subframe period for a blanking data set DE. A grayscale display is produced by turning on/off the pixel in the three subframe periods based on the data sets D1 to D3.

The time multiplexing grayscale display method is described in Japanese Unexamined Patent Publication (Tokukai) 2004-4501 and Japanese Unexamined Patent Publication (Tokukai) 2004-271899. No further description will be given here.

Next will be described the pixel circuit structure.

Referring to FIG. 14, the pixel circuit A4 has transistors (TFTs) Q12 to Q15, capacitors C5, C6, and an OLED (electro-optical element) EL1.

In the pixel circuit A4, the transistor (third switching transistor) Q13 and the transistor (driver transistor) Q12 are connected in series between a power supply line PS and the OLED EL1. The transistor Q12 is a driver transistor which supplies a drive current to the OLED EL1.

The capacitor (first capacitor) C5 and the capacitor (second capacitor) C6 are provided in series between the gate (current control terminal) and source (first current input/output terminal) of the transistor Q12. The contact of the capacitors C5, C6 will be referred to as contact A.

The transistor Q14 (second switching transistor) is provided between contact A and the source line Sj. The transistor (first switching transistor) Q15 is provided between the gate of the transistor Q12 and the potential line Ui.

The pixel circuit A4 employs the first current input/output control means to control the current input or output of the transistor Q12. The source of the transistor Q12 is connected to the drain (first current input/output terminal) of the transistor Q13 in this current input/output control means.

A second potential control means discussed below is preferably used to change the potential of the current control terminal of the transistor Q12. The potential control means changes the potential of the contact of the capacitors C5, C6 through the transistor Q14.

In the pixel circuit shown in FIG. 14, the transistors Q12, Q13 are p-type TFTs, whereas the transistors Q14, Q15 are n-type TFTs.

The gates of the transistor Q13, Q14, Q15 are connected respectively to the control line Ri, the gate line Gi, and the control line Wi.

FIG. 15 is a timing chart illustrating the operation of the pixel circuit A4. The operation of the pixel circuit A4 is controlled by the source driver 7 and the gate driver 3 in accordance with the aforementioned various signals supplied from the control circuit 12. The following will describe the operation of the pixel circuit A4 in reference to the timing chart in FIG. 15.

FIG. 15 shows timings of changes in the voltages applied to the control line Wi, the gate line Gi, the control line Ri, and the source line Sj. The lines Wi+1, Gi+1, Ri+1 are connected to the same source line Sj and associated with the pixel A(i+1)j connected to the gate line Gi+1 that is scanned following the gate line Gi. In addition, in the pixel circuit A4, a voltage Va, as voltage corresponding to blanking data DE shown in FIG. 15, is applied to the source line Sj.

A period from 0 to 4t1 is a select period for the pixel A4 (Aij) as shown in FIG. 15. First, the gate line Gi is set to GH (HIGH) at the onset of the select period, or at time 0, turning on the transistor Q14 to short-circuit contact A to the source line Sj. Since the data signal is representing the blanking data DE at that time, the data voltages Va are applied to the source lines S1 to Sm through the analog switches 10.

Under these conditions, since the control line Ri is GL, the transistor Q13 is ON, and the capacitor C6 holds a potential difference Va−Vp. The gate potential of the transistor Q12 cannot be determined. Assuming that the gate potential of the transistor Q12 is Vg, the capacitor C5 holds a voltage Va−Vg.

The gate line Gi is set to GL (LOW) at time 3t1, turning off the transistor Q14. That inhibits electric charge from moving via contact A.

The control line Wi is set to GH at time 5t1, turning on the transistor Q15. That applies the potential Vpc of the potential line Ui to the gate of the transistor Q12. Because the potential Vpc is such a potential that the transistor Q12 is turned on, the transistor Q12 is turned on.

The control line Ri is set to GH at time 6t1, turning off the transistor Q13. The source potential of the transistor Q12 converges to a potential Vpc+|Vth| (Vth is the threshold voltage).

Thereafter, the control line Wi is set to GL, turning off the transistor Q15. Furthermore, the control line Ri is set to GL, turning on the transistor Q13. Then, since the gate-to-source potential of the transistor Q12 is |Vth|, the transistor Q12 is turned off.

Under these conditions, electric charge cannot move via contact A, it is inferred that the following relationship holds between the potential Vx of contact A and other voltages:

$$C 5 ( Va - Vg ) + C 6 ( Va - Vp ) = C 5 ( Vx - ( Vp - \vert Vth \vert ) ) + C 6 ( Vx - Vp )$$

Accordingly, assuming that the charge stored in the capacitor C6 converges to C6 (Vx−Vp)≈C6 (Va−Vp) by repeating the 0 to 20t1 operation, Vx≈Va. Hence, the following relationship holds:

Vg≈Vp−|Vth|

The control line Gi is set to GH at time 24t1, turning on the transistor Q14. That applies the potential Vb from the source line Sj to contact A. Here, if the potential difference Va−Vg across the capacitor C5 converges to Va−(Vp−|Vth|), the transistor Q12 is turned on when Vb<Va and turned off when Vb≧Va.

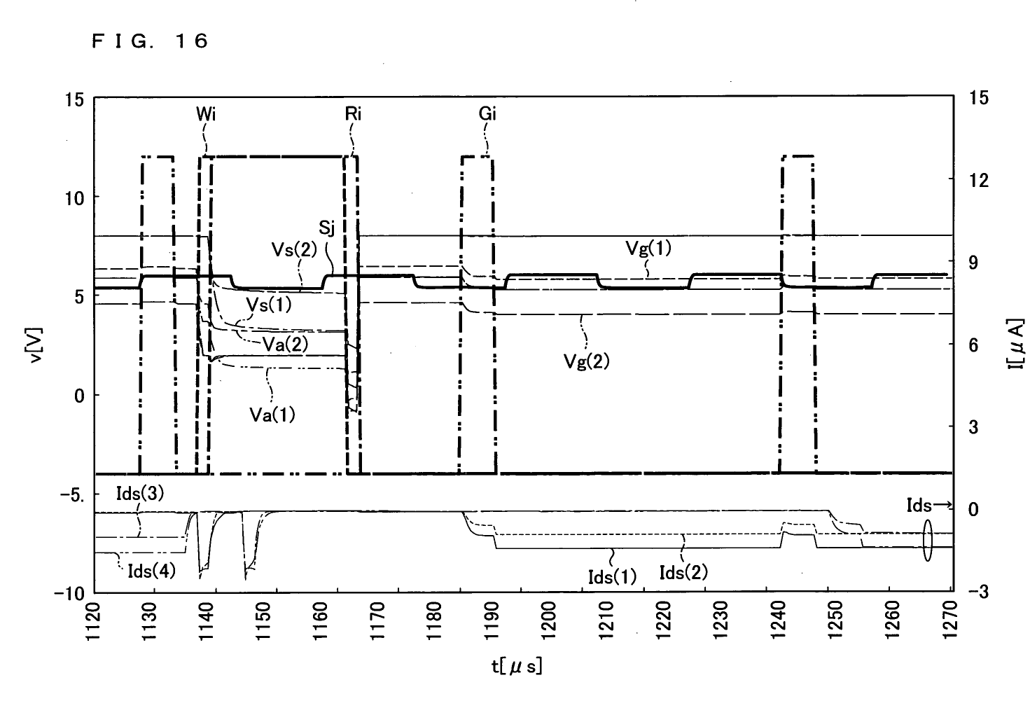

Now, results of simulation in which the 0 to 20t1 operation is repeated will be described. FIG. 16 shows results of simulation of the current Ids in the pixel circuit A4 based on properties of an OLED (GL=−4 V, GH=12 V, Vcom=0 V, Vp=10 V, Vpc=2 V, Va=6 V). FIG. 16 also shows the currents Ids(1) to Ids(4) after repeating the 0 to 20t1 operation in FIG. 15 five to six times, then setting the gate line Gi to GH over the period from 1.24 milliseconds to 1.246 milliseconds, and writing the data Vda (=5.4 V) from the source line Sj.

The current Ids(1) is a current flow through the pixel circuit Ai1 and corresponds to a case where the absolute value of the threshold voltage Vth of the transistor Q12 is a minimum (=Vth(min)) and the mobility μ is a maximum. The current Ids(2) is a current flow through the pixel circuit Aim and corresponds to a case where the absolute value of the threshold voltage Vth of the transistor Q12 is a maximum (=Vth(max)) and the mobility μ is a minimum. The current Ids(3) is a current flow through the pixel circuit A(i+1)1 and corresponds to a case where the absolute value of the threshold voltage Vth of the transistor Q12 is a maximum (=Vth(max)) and the mobility μ is a minimum. The current Ids(4) is a current flow through the pixel circuit A(i+1)m and corresponds to a case where the absolute value of the threshold voltage Vth of the transistor Q12 is a minimum (=Vth(min)) and the mobility μ is a maximum.

From the results of the simulation, Ids(1) ≈−1.37 μA, Ids(2) ≈−0.87 μA, Ids(3) ≈−1.34 μA, and Ids(4)≈−0.84 μA. Variations in the current Ids are about the same as those in mobility, which is safely interpreted as an indication of sufficient threshold compensation.

The repetition of the 0 to 20t1 operation will therefore likely cause the potential Vg to converge to Vp-|Vth|.

As discussed above, the present embodiment is capable of applying a threshold-compensated voltage to the gate of the transistor Q12 using four TFTs and two capacitors per pixel. Accordingly, the number of elements making up a screen can be reduced, allowing for pixel size reduction (albeit small). Thus, more pixels are accommodatable in a predetermined screen size, which in turn improves image quality. Therefore, one can achieve the first objective of the present invention by employing the present embodiment.

It is obvious, from a comparison of the results of simulation in FIG. 16 and those in FIG. 7 (comparative example with poor image quality), that the pixel circuit A4 of the present embodiment delivers good image quality. Therefore, one can also achieve the second objective of the present invention by employing the present embodiment.

### Embodiment 5

The pixel circuit structure of embodiment 4 above (FIG. 14) still needs four horizontal wires. In view of the first objective of the present invention, the fewer the horizontal wires, the better.

Referring to the pixel circuit structure shown in FIG. 14, the potential line Ui can also act as the adjacent control line Ri+1 if the control line Ri+1 is set to 0 V (=GL) and the control line Wi is set to −4 V (=GL).

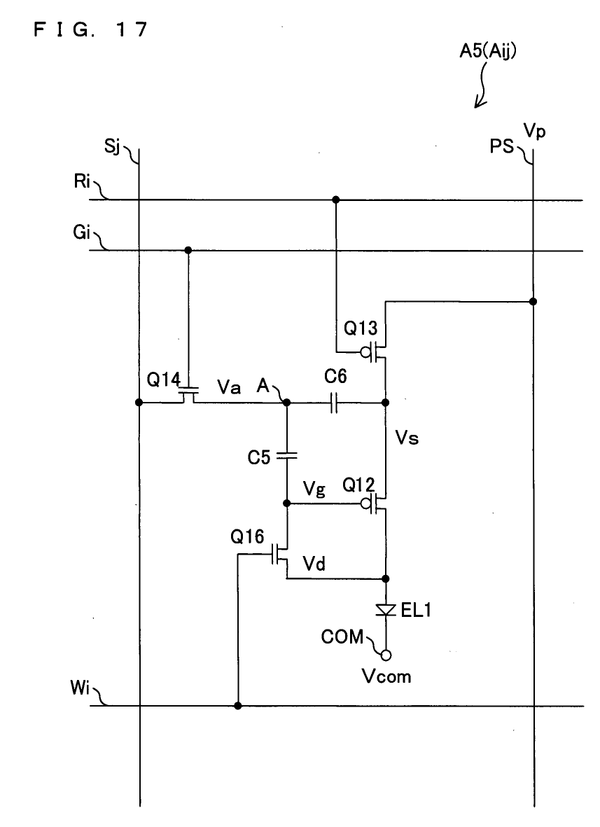

However, since the potential Vpc of the potential line Ui is not limited to a particular value in the pixel circuit A4 in FIG. 14, removing the potential line Ui poses no inconvenience. Accordingly, the pixel circuit A5 (Aij) of the present embodiment lacks the transistor Q15 and the potential line Ui and instead includes a transistor Q16 between the gate and drain of the transistor Q12 as shown in FIG. 17. In addition, the gate of the transistor Q16 is connected to the control line Wi. The pixel circuit A5 of the present embodiment is also provided in the display device 6; its description will not be repeated here.

Therefore, the pixel circuit structure A4 in FIG. 14 is the first current input/output control means which is preferred in controlling the current input or output of the transistor Q12, that is, the second case mentioned earlier which is classified in accordance with to which line the second current input/output terminal of the transistor Q15 (first switching transistor) is connected in the first current input/output control means.

The pixel circuit structure A5 in FIG. 17 is the first current input/output control means which is preferred in controlling the current input or output of the transistor Q12, that is, the third case mentioned earlier which is classified in accordance with to which line the second current input/output terminal of the transistor Q16 (first switching transistor) is connected in the first current input/output means.

The pixel circuit A5 operates as illustrated in the timing chart in FIG. 15; its description will not be repeated here.

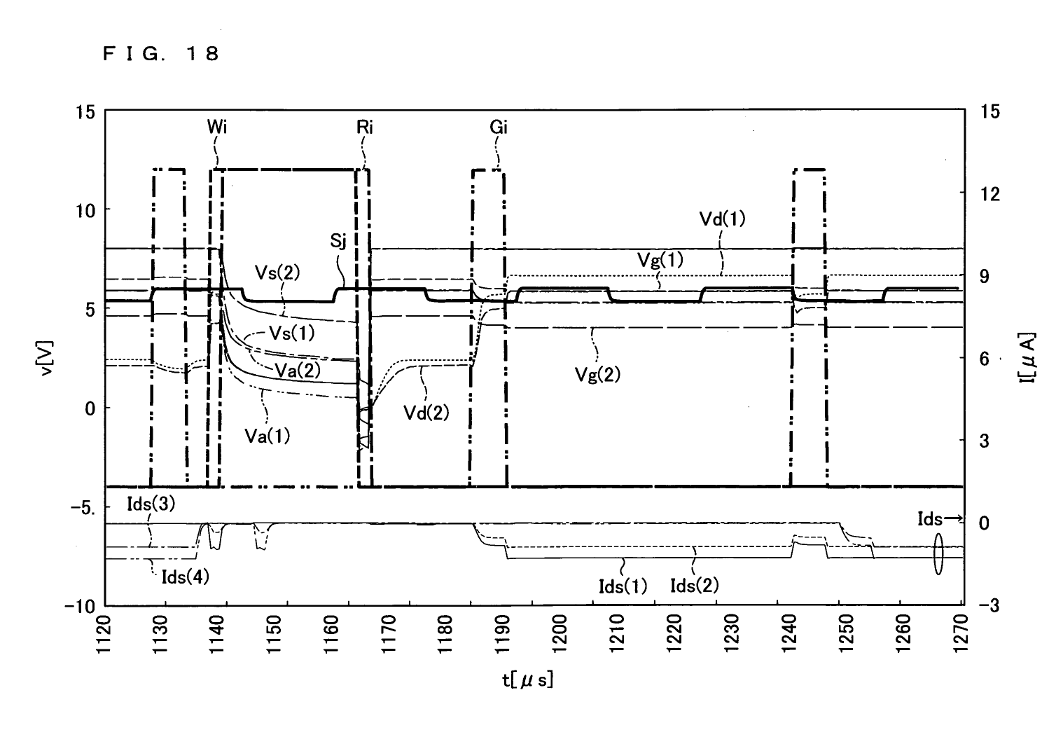

In the pixel circuit A5, the gate of the transistor Q12 is set to the same potential as the drain in the threshold compensation period. FIG. 18 shows results of simulation of the current Ids in the pixel circuit A5 under these conditions based on properties of an OLED (GL=−4 V, GH=12 V, Vcom=0 V, Vp=10 V, Vpc=2 V, Va=6 V).

Referring to FIG. 18, the 0 to 20t1 operation as in FIG. 15 is repeat five or six times. Thereafter, the gate line Gi is set to GH over the period from 1.24 milliseconds to 1.246 milliseconds to write the data Vda (=5.4 V) from the source line Sj. Consequently, Ids(1)≈−1.31 μA, Ids(2)≈−0.90 μA, Ids(3)≈−1.31 μA, and Ids(4)≈−0.90 μA.

The current Ids(1) is a current flow through the pixel circuit Ai1 and corresponds to a case where the absolute value of the threshold voltage Vth of the transistor Q12 is a minimum (=Vth(min)) and the mobility μ is a maximum. The current Ids(2) is a current flow through the pixel circuit Aim and corresponds to a case where the absolute value of the threshold voltage Vth of the transistor Q12 is a maximum (=Vth(max)) and the mobility μ is a minimum. The current Ids(3) is a current flow through the pixel circuit A(i+1)1 and corresponds to a case where the absolute value of the threshold voltage Vth of the transistor Q12 is a maximum (=Vth(max)) and the mobility μ is a minimum. The current Ids(4) is a current flow through the pixel circuit A(i+1)m and corresponds to a case where the absolute value of the threshold voltage Vth of the transistor Q12 is a minimum (=Vth(min)) and the mobility μ is a maximum.

As discussed above, the pixel circuit A5 of the present embodiment is capable of applying a threshold-compensated voltage to the gate of the transistor Q12 even if the gate of the transistor Q12 is set to the same potential as the drain in the threshold compensation period.

In addition, the pixel circuit structure of the present embodiment includes a fewer wires than the pixel circuit structure in embodiment 4 (FIG. 14), allowing for pixel size reduction (albeit small). Thus, more pixels are accommodatable in a predetermined screen size, which in turn improves image quality. Therefore, one can achieve the first objective of the present invention by employing the pixel circuit structure of the present embodiment.

It is obvious, from a comparison of the results of simulation in FIG. 18 and those in FIG. 7 (comparative example with poor image quality), that the pixel circuit A5 of the present embodiment delivers good image quality, similarly to the results of simulation in FIG. 16 (embodiment 4).

Therefore, one can also achieve the second objective of the present invention by employing the pixel circuit structure of the present embodiment.

### Embodiment 6

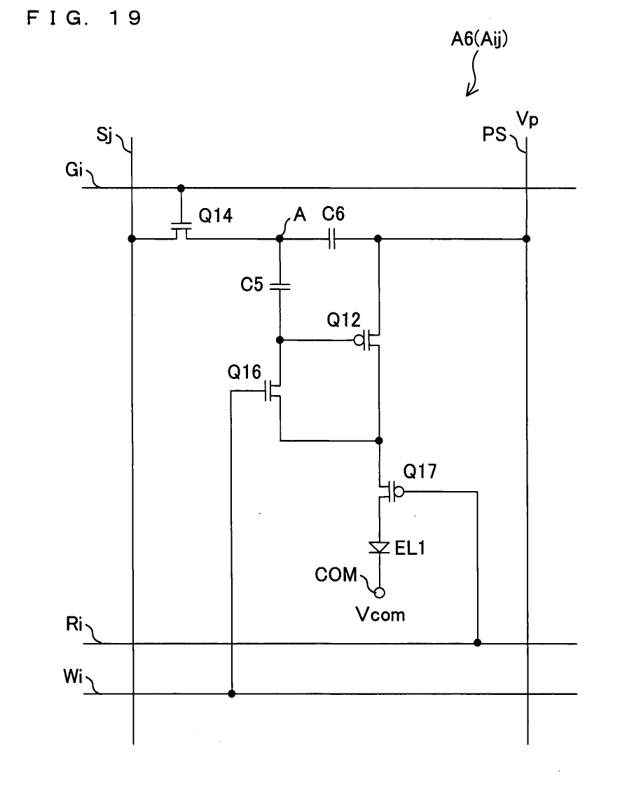

The present embodiment will describe a pixel circuit A6 (Aij) shown in FIG. 19 which has similar pixel circuit structure to the pixel circuit structure shown in FIG. 17. Members of the present embodiment that have the same arrangement and function as members of embodiment 4 are indicated by the same reference numerals.

The pixel circuit A6 has transistors (TFTs) Q12, Q14, Q16, Q17, capacitors C5, C6, and an OLED (electro-optical element) EL1 as shown in FIG. 19, similarly to FIG. 17. The pixel circuit A6 of the present embodiment is provided in the display device 6 (FIG. 13) already discussed; its description will not be repeated here.

In the pixel circuit A6, the transistor (driver transistor) Q12 and the transistor (third switching transistor) Q17 are connected in series between a power supply line PS and the OLED EL1.

The capacitor (first capacitor) C5 and the capacitor (second capacitor) C6 are provided in series between the gate (current control terminal) and source (first current input/output terminal) of the transistor Q12. The transistor (second switching transistor) Q14 is provided between contact A between the capacitors C5, C6 and the source line Sj. The transistor (first switching transistor) Q16 is provided between the gate and drain of the transistor Q12.

The pixel circuit A6 employs the second current input/output control means to control the current input or output of the transistor Q12. In the current input/output means, the drain (second current input terminal) of the transistor Q12 is connected to the source (first current input/output terminal) of the transistor Q17 (third switching transistor), and the transistor Q16 is connected between the current control terminal and the second current input/output terminal of the transistor Q12.

The pixel circuit A6 preferably employs the second potential control means to change the potential of the current control terminal of the transistor (driver transistor) Q21. The potential control means changes the potential of contact A through the transistor Q14.

The gates of the transistors Q17, Q14, Q16 are connected respectively to the control line Ri, the gate line Gi, and the control line Wi.

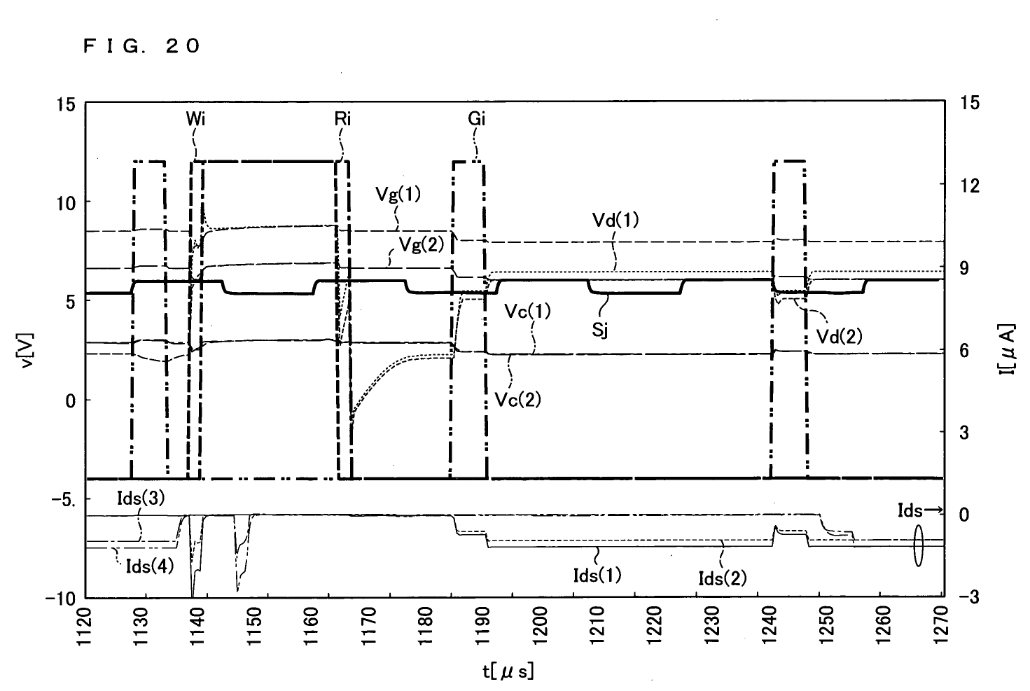

The operation of the pixel circuit A6 can be illustrated by the same timing chart as the one in FIG. 15 for embodiment 5. The operation of the pixel circuit A6 is controlled by the source driver 7 and the gate driver 3 in accordance with the aforementioned various signals supplied from the control circuit 12. The following will describe the operation of the pixel circuit A6 in reference to the timing chart in FIG. 20.

A period from 0 to 4t1 is a select period for the pixel circuit A6 as shown in FIG. 15. First, the gate line Gi is set to GH (HIGH) at the onset of the select period, or at time 0, turning on the transistor Q14 to short-circuit contact A to the source line Sj. Since the data signal is representing the blanking data DE at that time, the data voltages Va are applied to the source lines S1 to Sm through the analog switches 10.

Under these conditions, the capacitor C6 holds a potential difference Va−Vp. Assuming that the gate potential of the transistor Q12 is Vg, the capacitor C5 holds a voltage Va−Vg.

The gate line Gi is set to GL (LOW) at time 3t1, turning off the transistor Q14. That inhibits electric charge from moving via contact A.

The control line Wi is set to GH at time 5t1, turning on the transistor Q16. Then, since the control line Ri is GL, the transistor Q17 is also on. Accordingly, the gate and drain of the transistor Q12 have the same potential; the transistor Q12 is turns on.

The control line Ri is set to GH at time 6t1, turning off the transistor Q17. The gate potential of the transistor. Q12 changes to a potential Vp−|Vth| (Vth is the threshold voltage), turning off the transistor Q12.

Thereafter, the control line Wi is set to GL, turning off the transistor Q16. Furthermore, the control line Ri is set to GL, turning on the transistor Q17. Then, since the gate-to-source potential of the transistor Q12 is |Vth|, the transistor Q12 is turned off.

Under these conditions, electric charge cannot move via contact A, it is inferred that the following relationship holds between the potential Vx of contact A and other voltage:

$$C 5 ( Va - Vg ) + C 6 ( Va - Vp ) = C 5 ( Vx - ( Vp - \vert Vth \vert ) ) + C 6 ( Vx - Vp )$$

Accordingly, assuming that the charge stored in the capacitor C6 converges to C6 (Vx−Vp)≈C6 (Va−Vp) by repeating the aforementioned operation, Vx≈Va. Hence, the following relationship holds:

Vg≈Vp−|Vth|

The control line Gi is set to GH at time 24t1, turning on the transistor Q14. That applies the potential Vb from the source line Sj to contact A. Here, if the potential difference Va−Vg across the capacitor C5 converges Va−(Vp−|Vth|), the transistor Q12 is turned on when Vb<Va and turned off when Vb≧Va.

Now, results of simulation in which the 0 to 20t1 operation is repeated will be described. FIG. 20 shows results of simulation of the current Ids in the pixel circuit A6 based on properties of an OLED (GL=−4 V, GH=12 V, Vcom=0 V, Vp=10 V, Vpc=2 V, Va=6 V).

FIG. 20 also shows the currents Ids(1) to Ids(4) after setting the gate line Gi to GH over the period from 1.24 milliseconds to 1.246 milliseconds and writing the data Vda (=5.4 V) from the source line Sj.

The current Ids(1) is a current flow through the pixel circuit Ai1 and corresponds to a case where the absolute value of the threshold voltage Vth of the transistor Q12 is a minimum (=Vth(min)) and the mobility μ is a maximum. The current Ids(2) is a current flow through the pixel circuit Aim and corresponds to a case where the absolute value of the threshold voltage Vth of the transistor Q12 is a maximum (=Vth(max)) and the mobility μ is a minimum. The current Ids(3) is a current flow through the pixel circuit A(i+1)1 and corresponds to a case where the absolute value of the threshold voltage Vth of the transistor Q12 is a maximum (=Vth(max)) and the mobility μ is a minimum. The current Ids(4) is a current flow through the pixel circuit A(i+1)m and corresponds to a case where the absolute value of the threshold voltage Vth of the transistor Q12 is a minimum (=Vth(min)) and the mobility μ is a maximum.

From the results of the simulation, the current Ids(1)≈−1.37 μA, the current Ids(2)≈−0.87 μA, the current Ids(3)≈−1.34 μA, and the current Ids(4) ≈−0.84 μA. Variations in the current Ids are about the same as those in mobility, which is safely interrupted as an indication of sufficient threshold compensation.

Therefore, in the present pixel circuit structure, the repetition of the 0 to 20t1 operation in FIG. 15 will again likely cause the potential Vg to converge to Vp−|Vth|.

As discussed above, the pixel circuit structure of the present embodiment is capable of applying a threshold-compensated voltage to the gate of the transistor Q12 using four TFTs and two capacitors per pixel. Accordingly, the number of elements making up a screen can be reduced, allowing for pixel size reduction (albeit small). Thus, more pixels are accommodatable in a predetermined screen size, which in turn improves image quality. Therefore, one can achieve the first objective of the present invention by employing the pixel circuit structure of the present embodiment.

It is obvious, from a comparison of the results of simulation in FIG. 20 and those in FIG. 7 (comparative example with poor image quality), that the pixel circuit A6 of the present embodiment delivers good image quality, similarly to the results of simulation in FIG. 18 (embodiment 5). Therefore, one an also achieve the second objective of the present invention by employing the pixel circuit structure of the present embodiment.

A comparison of simulation results in FIG. 20 and FIG. 18 reveals that the gate voltage of the driver transistor Q12 in FIG. 18 keep changing in the second period, i.e., while the control lines Ri, Wi are GH. It is therefore difficult to determine whether the driver transistor has been threshold compensated.

In contrast, in FIG. 20, the gate voltage of the driver transistor Q12 relatively quickly converges in the second period, i.e., while the control lines Ri, Wi are GH. It is therefore easy to determine whether the driver transistor has been threshold compensated.

As discussed above, the pixel circuit A6 of the present embodiment is preferable because of its advantage that it allows easy settings of its variables through simulation.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The display device of the present invention employs a structure which includes a reduced number of elements and wires in pixel circuits, thereby reducing the pixel size and increasing the number of pixels. As a result, image quality is improved. The invention is hence suitably applied to display devices which contain current-driven-type display elements.

1. A display device including a matrix of electro-optical elements and driver transistors driving the electro-optical elements, said device comprising at each matrix point:
a first capacitor and a second capacitor provided in series between a current control terminal and first current input/output terminal of an associated one of the driver transistors;
a first switching transistor having a first current input/output terminal connected to the current control terminal of that driver transistor;
a second switching transistor having a first current input/output terminal connected a contact of the first and second capacitors; and
a third switching transistor having a first current input/output terminal connected to either the first current input/output terminal of the driver transistor or a second current input/output terminal of the driver transistor,
wherein
either the first switching transistor or the second switching transistor has a second current input/output terminal connected to a signal line.

2. The display device of claim 1, wherein:
the first current input/output terminal of the third switching transistor is connected to the first current input/output terminal of the driver transistor;
the first switching transistor has a second current input/output terminal connected to a potential line; and
the second switching transistor has a second current input/output terminal connected to the signal line.

3. The display device of claim 1, wherein:
the first current input/output terminal of the third switching transistor is connected to the first current input/output terminal of the driver transistor;
the first switching transistor has a second current input/output terminal connected to the second current input/output terminal of the driver transistor; and
the second switching transistor has a second current input/output terminal connected to the signal line.

4. The display device of claim 1, wherein:
the first current input/output terminal of the third switching transistor is connected to the second current input/output terminal of the driver transistor;
the first switching transistor has a second current input/output terminal connected to the second current input/output terminal of the driver transistor; and
the second switching transistor has a second current input/output terminal connected to the signal line.

5. The display device of claim 1, wherein:
the first current input/output terminal of the third switching transistor is connected to the first current input/output terminal of the driver transistor;
the first switching transistor has a second current input/output terminal connected to the signal line; and
the second switching transistor has a second current input/output terminal connected to a potential line.

6. The display device of claim 5, said device further comprising at each matrix point a fourth switching transistor provided in parallel with the first capacitor.

7. A method of driving a display device including a matrix of electro-optical elements and driver transistors driving the electro-optical elements,
said device including at each matrix point a first capacitor and a second capacitor provided in series between a current control terminal and first current input/output terminal of an associated one of the driver transistors,
said method comprising the steps of:
applying a first potential to the current control terminal of that driver transistor in a first period and applying a second potential to a contact of the first and second capacitors;
controlling a current input to the driver transistor or a current output from the driver transistor in a second period, so as to produce a potential difference equal to a threshold voltage of the driver transistor between the current control terminal and first current input/output terminal of the driver transistor; and
changing a potential of the current control terminal in a third period.
